(19) United States
(12) Patent Application Publication
(10) Pub. No.: US 2026/0310880 A1
(43) Pub. Date: Oct. 8, 2026

(54) SYSTEMS AND METHODS FOR DOMAIN-COMPATIBLE ELECTRONIC DOCUMENT GENERATION

(71) Applicant: Avalara, Inc., Seattle, WA (US)

(72) Inventors: SravanKumar Kadimisetty, Bengaluru (IN); Chandrakant Kapadnis, Pune (IN); Vaibhav Chawla, Agra (IN); Sudhir Kamble, Pune (IN); Tim Schiemer, Neckarsulm (DE)

(21) Appl. No.: 19/170,654

(22) Filed: Apr. 4, 2025

(51) Int. Cl. G06F 40/166; G06F 16/334; G06F 40/205

(52) U.S. Cl. CPC G06F 40/166; G06F 16/3347; G06F 40/205

(57) ABSTRACT

A system for domain-compatible electronic document generation ingests data from multiple sources, extracts relevant information, generates embeddings stored in a vector database, and maintains current document requirements for multiple domains. Upon receiving a prompt containing entity and relationship information, a large language model analyzes the prompt, segregates data into components, queries the vector database for applicable domain-specific requirements, and generates a compliant technical document. The document undergoes multi-stage validation including structural, domain-specific rule, and domain entity response validation. Validation feedback refines future document generation. The system delivers the validated document in both technical and human-readable formats, enabling users without specialized knowledge to produce compliant electronic documents efficiently.

### TECHNICAL FIELD

The technical field relates to computer networks, and particularly to the technology of automated networked systems for domain-compatible electronic document generation.

### BRIEF SUMMARY

The present description gives instances of specialized computer systems, devices, methods and storage media that may store and implement computer programs and technical processes. An example embodiment includes systems and methods for domain-compatible electronic document generation using artificial intelligence. The system electronically ingests data from multiple sources including domain entity websites, EDI providers, and CRM data stores, extracts relevant information, generates embeddings, and maintains a vector database with current document requirements for multiple domains. When a user submits a prompt containing entity and relationship information, the system uses a large language model to analyze the prompt, query the vector database for applicable domain-specific requirements, and generate a compliant technical document. This document undergoes multi-stage validation including structural validation, domain-specific rule validation, and domain entity response validation, with validation feedback used to refine future document generation. The validated document is delivered to the user in both technical and human-readable formats, enabling users without specialized knowledge to efficiently produce compliant electronic documents across multiple domains.

In one example embodiment, a method includes electronically ingesting data from a plurality of data sources including domain entity websites, electronic data interchange (EDI) providers and customer relationship management (CRM) data stores; electronically extracting relevant data from the ingested data; electronically generating embeddings of the extracted data and storing the embeddings in a vector database; maintaining the vector database with current electronic document requirements for multiple domains; electronically receiving a prompt from a user device, the prompt including information about a first entity, a second entity, and relationship instance details; in response to receiving the prompt, using a large language model (LLM) to electronically analyze and segregate the prompt data into separate components including at least first entity information, second entity information, and relationship instance information; electronically querying the vector database using the segregated prompt data to identify domain-specific requirements applicable to the relationship instance; using the LLM to electronically generate a technical document based on the segregated prompt data and the identified domain-specific requirements; electronically validating the generated technical document through a multi-stage validation process including at least structural validation, domain-specific rule validation, and domain entity response validation; using the LLM to electronically process feedback regarding validation errors to refine subsequent document generation; and electronically delivering the validated document to the user device in both technical format and human-readable format.

In one example embodiment, the method includes implementing a web scraping mechanism configured to automatically monitor and detect updates to domain entity websites when electronically ingesting data from the plurality of data sources.

In one example embodiment, the method includes identifying and extracting document structure specifications, validation rules, and domain-specific terminology from the ingested data when electronically extracting relevant data from the ingested data.

In one example embodiment, the method includes creating vector representations of domain-specific requirements for each domain and organizing the vector representations into clusters based on similarity of requirements across domains when electronically generating embeddings of the extracted data.

In one example embodiment, the method includes detecting changes in domain entity requirements, updating the e-invoicing domain model, and logging the changes with timestamps to maintain a historical record of requirement modifications while maintaining the vector database.

In one example embodiment, the method includes receiving a natural language description of a desired document without requiring specific formatting or domain knowledge from a user when electronically receiving a prompt from a user device.

In one example embodiment, the method includes using a nearest-neighbor algorithm to match prompt elements with corresponding document components based on vector similarity when using the LLM to electronically analyze and segregate the prompt data.

In one example embodiment, the method includes determining the domains applicable to both the first entity and the second entity and identifying cross-domain requirements applicable to the relationship instance when electronically querying the vector database.

In one example embodiment, the method includes generating a document object model (DOM) representation of the technical document, populating required fields based on the segregated prompt data, and automatically generating placeholder values for any missing required fields when using the LLM to electronically generate a technical document.

In one example embodiment, the method includes notifying a user of any automatically generated placeholder values and providing an interface for the user to modify or confirm the placeholder values.

In one example embodiment, the method includes validating the generated technical document against XML Schema Definitions (XSDs) to facilitate document structural correctness when performing the structural validation.

In one example embodiment, the method includes validating the generated technical document against structural schema rules to facilitate compliance with domain-specific rules when performing the domain-specific rule validation.

In one example embodiment, the method includes submitting the generated technical document to a test endpoint provided by a domain entity and processing the response to identify any compliance issues when performing the domain entity response validation.

In one example embodiment, the method includes categorizing validation errors based on error type and severity, updating model parameters based on error patterns, and refining document generation templates to prevent recurring errors when using the LLM to electronically process feedback.

In one example embodiment, the method includes generating an XML format of the technical document, generating a human-readable PDF format of the technical document, and providing both formats to the user device with annotations indicating the correlations between elements in both formats when electronically delivering the validated document.

In one example embodiment, the method includes maintaining an electronic log of document generation transactions, recording success and failure metrics for each transaction, and generating performance analytics to identify improvement opportunities in the document generation process.

In one example embodiment, the method includes electronically submitting the validated document to a domain entity on behalf of the user upon receiving user authorization.

In one example embodiment, the method includes detecting changes in domain requirements that affect previously generated documents, automatically notifying users of such changes, and providing an option to regenerate affected documents with updated requirements. For example, when a customer sends an e-invoice document to the model, it may send a synchronous response back to the user with updated details. An example portion of such a response may be “these portions of the data fields have been changed”.

In one example embodiment, the method includes implementing a synchronization mechanism that facilitates consistency between the vector database and current domain entity requirements by periodically validating and updating the vector database against authoritative sources.

In one example embodiment, the method includes encrypting sensitive information contained within the generated technical document, generating access logs tracking all interactions with the document, and implementing digital verification mechanisms to authenticate an origin and integrity of the document.

The domain-compatible electronic document generation system provides several technical improvements that enhance hardware efficiency, reduce latency, and conserve computational resources. These improvements enable tasks to be performed by less capable, capacious, and/or expensive hardware devices while preserving resources for other tasks.

The system's vector database with embedded knowledge of domain-specific requirements significantly reduces the computational resources needed for document generation. By transforming complex regulatory requirements and document specifications into optimized vector representations, the system minimizes the memory footprint required to store and process this information. Traditional systems would require extensive rule databases and complex conditional logic structures that consume substantial memory and processing resources. The vector-based technique enables more efficient storage and retrieval of domain knowledge, allowing the system to operate on hardware devices with more modest specifications.

The web scraping mechanism that automatically monitors and detects updates to domain entity websites operates with intelligent differential analysis. Rather than repeatedly downloading entire websites or documentation, the system identifies and extracts only changed content, significantly reducing network bandwidth consumption. This technique enables the system to maintain current document requirements while minimizing data transfer overhead. The reduction in network traffic is particularly beneficial for organizations operating in environments with limited bandwidth or those facing bandwidth-based cost structures.

The LLM-based prompt segregation process efficiently analyzes and separates input data into distinct components (entity information, relationship details, etc.), enabling parallel processing of these components. This segregation technique reduces processing interdependencies and allows for more efficient resource allocation. By processing distinct data components in parallel rather than sequentially analyzing complex relationships, the system significantly reduces processing time and computational load. This optimization allows the same task to be performed with less capable hardware and with reduced latency.

The system's use of nearest-neighbor algorithms to match prompt elements with document components based on vector similarity represents a significant computational improvement over traditional pattern-matching or rule-based approaches. Vector similarity operations can be highly optimized and often require fewer computational cycles than extensive conditional logic evaluation. This efficiency enables the document generation process to complete with lower latency and reduced processor utilization, allowing the same hardware to handle more concurrent document generation requests.

The multi-stage validation process (structural validation, domain-specific rule validation, and domain entity response validation) employs a progressive filtering technique that prioritizes computationally inexpensive validations before proceeding to more resource-intensive checks. This progressive validation approach prevents wasting computational resources on complex domain-specific validations for documents that fail basic structural requirements. By failing early when issues are detected, the system preserves processing capacity that would otherwise be consumed by comprehensive validation of fundamentally flawed documents.

The system's feedback processing mechanism categorizes validation errors and adapts the document generation process based on historical patterns. This adaptive behavior focuses computational resources on the specific aspects of document generation that have historically presented challenges while streamlining processing for well-understood document components. The result is a more efficient allocation of computational resources that reduces overall processing requirements and enables the system to operate effectively on less powerful hardware platforms.

The system's technique of preprocessing and storing embeddings of extracted data significantly reduces the latency of document generation requests. Rather than processing raw regulatory documents and specifications at request time, the system leverages pre-computed embeddings to quickly identify relevant requirements. This preprocessing approach shifts computational load to non-time-critical maintenance periods, reducing the real-time processing requirements when generating documents in response to user requests. The resulting latency reduction improves system responsiveness even on hardware with modest processing capabilities.

The architecture enables efficient workload distribution across multiple processing nodes, allowing organizations to leverage clusters of less expensive hardware rather than requiring high-capacity individual machines. By separating data ingestion, embedding generation, prompt processing, and validation into distinct components that can operate independently, the system can scale horizontally across multiple modest devices rather than requiring vertical scaling of individual hardware components. This distribution technique preserves resources by allocating them more precisely to the specific tasks that require them.

In one example embodiment, the method includes a data extraction module that ingests data into the e-invoicing domain model, training it with new patterns from legitimate sources while enabling the model to segregate prompt data, generate technical documentation, and validate documents. The e-invoicing domain model processes natural language prompts, interprets user input, consults the vector database for necessary corrections, and provides real-time responses with updated technical documents, while simultaneously learning from monitored errors through a continuous feedback loop that enhances accuracy.

The e-invoicing domain model further automates document processing by updating based on newly ingested data sources, producing technical documents in multiple formats, validating them using mechanisms such as a rule-based validation language (e.g., Schematron), XML Schema Definitions (XSD), and tax authority application programming interfaces (APIs), and separating technical documentation into domain segments (e.g., supplier information, buyer information) that are returned to the vector database for embedding creation. This comprehensive technique ensures accurate, validated documents are delivered to users while maintaining continuous improvement of the system through automated learning.

### Data Extraction Module

Through these technical improvements, the domain-compatible electronic document generation system significantly enhances the efficiency of computational resource utilization, enables operation on less capable and less expensive hardware, reduces processing latency, and preserves computational resources for other tasks or additional instances of document generation processing. These and other features and advantages of the claimed invention will become more readily apparent in view of the embodiments described and illustrated in this specification, namely in this written specification and the associated drawings.

### BRIEF DESCRIPTION OF THE SEVERAL VIEWS OF THE DRAWINGS

The components in the drawings are not necessarily drawn to scale relative to each other. Like reference numerals designate corresponding parts throughout the several views.

FIG. 1 is a diagram showing sample aspects of a system for domain-compatible electronic document generation, showing system components including an Electronic Document Payload Generator and service engine interacting with digital rules, in accordance with some example embodiments described herein.

FIG. 2 is a diagram showing conditions and consequents of digital rules and their processing flow that repeats and expands upon the digital main rules 170 of FIG. 1, and juxtaposes them with a flowchart portion for a sample method of how it may be recognized that conditions of a certain digital main rule can be met for its consequent to be applied, in accordance with some example embodiments described herein.

FIG. 3A is a flowchart for illustrating a sample method according to embodiments of the present disclosure.

FIG. 3B is a flowchart for illustrating another sample method according to embodiments of the present disclosure.

FIG. 3C is a flowchart for illustrating another sample method according to embodiments of the present disclosure.

FIG. 3D is a flowchart for illustrating another sample method according to embodiments of the present disclosure.

FIG. 3E is a flowchart for illustrating another sample method according to embodiments of the present disclosure.

FIG. 4 is a block diagram showing additional components of sample computer systems according to embodiments of the present disclosure.

FIG. 5 is a diagram of sample aspects for describing operational examples and use cases of embodiments of the present disclosure.

FIG. 6 is a diagram illustrating the E-Invoice Payload Generation Domain Model Process of a Generative AI-powered E-Invoice Payload Generator system according to embodiments of the present disclosure.

FIG. 7 is a flow diagram showing three interconnected subflows of the E-Invoicing Payload Generation Domain Model Process according to embodiments of the present disclosure.

FIG. 8 is a detailed system architecture diagram of the Generative AI-powered E-Invoice Payload Generator according to embodiments of the present disclosure.

FIG. 9 is a validation and feedback process diagram of the Generative AI-powered E-Invoice Payload Generator system according to embodiments of the present disclosure.

FIGS. 10A-10D collectively illustrate an example of a technical e-invoice document in XML format that has been automatically generated by the Generative AI-powered E-Invoice Payload Generator system according to embodiments of the present disclosure.

FIG. 11 illustrates an example user interface of the Generative AI-powered E-Invoice Payload Generator system showing how users interact with the system to generate e-invoice documents according to embodiments of the present disclosure.

FIG. 12 illustrates an example user interface showing the validation and autocorrection feedback provided by the Generative AI-powered E-Invoice Payload Generator system after an e-invoice has been generated with the autocorrection feature enabled according to embodiments of the present disclosure.

FIG. 13 illustrates an example user interface showing the e-invoice submission process of the Generative AI-powered E-Invoice Payload Generator system when the submit invoice option has been selected according to embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, that embodiments of the inventive subject matter may be practiced without these specific details. In general, well-known structures and methods associated with underlying technology have not been shown or described in detail to avoid unnecessarily obscuring descriptions of the preferred embodiments. Additionally, the various embodiments may be methods, systems, media, or devices. Accordingly, the various embodiments may be entirely hardware embodiments, entirely software embodiments, or embodiments combining software and hardware aspects.

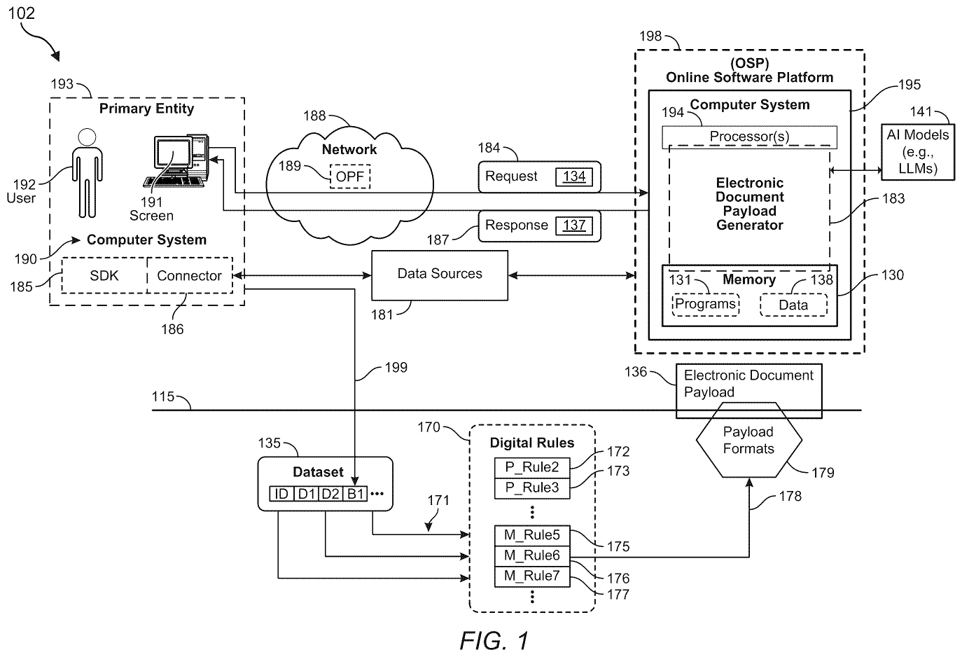

FIG. 1 is a diagram showing sample aspects of embodiments of the present disclosure. In particular, in an example embodiment, a system 102 electronically generates, via the electronic document payload generator 183 of the OSP 198, an electronic document payload 179 based on applying digital rules 170 to a dataset 135 of a client, such as primary entity 193. The OSP 198 may use data received via communication network 188 from a variety of sources, such as primary entity 193 and other entities and systems to produce an electronic document payload 179.

A thick line 115 separates this diagram, although not completely or rigorously, into a top portion and a bottom portion. Above the line 115 the emphasis is mostly on entities, components, their relationships, and their interactions, while below the emphasis is mostly processing of data that takes place often within one or more of the components above the line 115.

Above the line 115, a sample computer system 195 according to embodiments is shown. The computer system 195 has one or more processors 194 and a memory 130. The memory 130 stores programs 131 and data 138. The one or more processors 194 and the memory 130 of the computer system 195 thus implement electronic document payload generator 183. The data 138 may include, among other types of content, data associated with user 192, the primary entity 193, and/or relationship instances associated with user 192 and/or primary entity 193. Additional implementation details for the computer system 195 are given later in this document.

The computer system 195 can be located in “the cloud.” In fact, the computer system 195 may optionally be implemented as part of an online software platform (OSP) 198. The OSP 198 can be configured to perform one or more predefined services, for example, via operations of the electronic document payload generator 183. Such services can be, but are not limited to: searches, determinations, computations, verifications, electronic document payloads, the transmission of specialized information, including electronic document payloads, the generation and transmission of documents, online accessing of other systems, and so on, including what is described in this document. Such services can be provided as a Software-as-a-Service (SaaS).

In some embodiments, the computer system 195 may communicate with AI models 141, such as large language models (LLMs), to assist with electronic document generation. The AI models 141 may be accessed by the electronic document payload generator 183 through bidirectional communication, enabling the system to leverage different models to analyze prompts and generate appropriate domain-compatible electronic documents.

A user 192 may be standalone. The user 192 may use a computer system 190 that has a screen 191, on which User Interfaces (UIs) may be shown. Additional sample implementation details for the computer system 190 are given later in this document. In embodiments, the user 192 and the computer system 190 are considered part of primary entity 193, which can be referred to also merely as entity. In such instances, the user 192 can be an agent of the entity 193, and even within a physical site of the entity 193, although that is not necessary. In embodiments, the computer system 190 or other device of the user 192 or the entity 193 are client devices for the computer system 195.

The computer system 190 may access the computer system 195 via a communication network 188, such as the internet. In particular, the entities and associated systems of FIG. 1 may communicate via physical and logical channels of the communication network 188. For example, information may be communicated as data using the Internet Protocol (IP) suite over a packet-switched network such as the Internet or other packet-switched network, which may be included as part of the communication network 188. The communication network 188 may include many different types of computer networks and communication media including those utilized by various different physical and logical channels of communication, now known or later developed.

Downloading or uploading may be permitted from one of these two computer systems to the other, and so on. Such accessing can be performed, for instance, with manually uploading files, like spreadsheet files, etc. Such accessing can also be performed automatically as shown in the example of FIG. 1. The computer system 190 and the computer system 195 may exchange requests and responses with each other. Such can be implemented with a number of architectures.

In one such architecture, a device remote to the electronic document payload generator 183, such as computer system 190, may have a certain application (not shown) and a connector 186 that is a plugin that sits on top of that certain application. The connector 186 may be able to fetch from the remote device the details required for the service desired from the OSP 198, form an object or payload 134, and then send or push a request 184 that carries the payload 134 to the electronic document payload generator 183 via a service call. The electronic document payload generator 183 may receive the request 184 with the payload 134. The electronic document payload generator 183 may then apply digital rules 170 to the payload 134 to determine a requested electronic document payload 179, form a payload 137 that is an aspect of the electronic document payload 179, and then push, send, or otherwise cause to be transmitted a response 187 that carries the payload 137 to the connector 186. The connector 186 reads the response 187, and forwards the payload 137 to the certain application.

Moreover, in some embodiments, data from the computer system 190 and/or from the computer system 195 may be stored in an Online Processing Facility (OPF) 189 that can run software applications, perform operations, and so on. In such embodiments, requests and responses may be exchanged with the OPF 189, downloading or uploading may involve the OPF 189, and so on. In such embodiments, the computer system 190 and any devices of the OPF 189 can be considered to be remote devices, at least from the perspective of the computer system 195.

In embodiments, the computer system 195 receives one or more datasets. A sample received dataset 135 is shown below the line 115. The dataset 135 may be received by the computer system 195 in a number of ways. In some embodiments, one or more requests may be received by the computer system 195 via a network. In this example, a request 184 is received by the computer system 195 via the network 188. The request 184 has been transmitted by the remote computer system 190. The received one or more requests can carry payloads. In this example, the request 184 carries payload 134. In such embodiments, the one or more payloads may be parsed by the computer system 195 to extract the dataset. In this example, the payload 134 can be parsed by the computer system 195 to extract the dataset 135. In this example the single payload 134 encodes the entire dataset 135, but that is not required. In fact, a dataset can be received from the payloads of multiple requests. In such cases, a single payload may encode only a portion of the dataset. And, of course, the payload of a single request may encode multiple datasets. Additional computers may be involved with the network 188, some beyond the control of the user 192 or OSP 198, and some within such control.

The dataset 135 has values that can be numerical, alphanumeric, Boolean, and so on, as needed for what the values characterize. For example, an identity value ID may indicate an identity of the dataset 135, so as to differentiate it from other such datasets. At least one of the values of the dataset 135 may characterize an attribute of an entity or relationship instance, as indicated by arrows 199. For instance, a value D1 may be the name of an entity, a value D2 may be for relevant data of the entity, and so on. Plus, an optional value B1 may be a numerical base value for an aspect of the dataset, and so on. The dataset 135 may further have additional such values, as indicated by the horizontal dot-dot-dot to the right of the dataset 135.

In embodiments, stored digital rules 170 may be accessed by the computer system 195. These rules 170 are digital in that they are implemented for use by software. For example, these rules 170 may be implemented within programs 131 and data 138. The data portion of these rules 170 may alternately be implemented in memories in other places, which can be accessed via the network 188. These rules 170 may be accessed responsive to receiving a dataset, such as the dataset 135.

The digital rules 170 may include main rules, which can thus be accessed by the computer system 195. In this example, three sample digital main rules are shown explicitly, namely M_RULE5 175, M_RULE6 176, and M_RULE7 177. In this example, the digital rules 170 also include digital precedence rules P_RULE2 172 and P_RULE3 173, which can thus be further accessed by the computer system 195. The digital rules 170 may include additional rules and types of rules, as suggested by the vertical dot-dot-dots.

In embodiments, a certain one of the digital main rules may be identified from among the accessed stored rules by the computer system 195. In particular, values of the dataset 135 can be tested, according to arrows 171, against logical conditions of the digital main rules, as described later in this document. In this example, the certain main rule M_RULE6 176 is thus identified, which is indicated also by the beginning of an arrow 178 that is described in more detail later in this document. Identifying may be performed in a number of ways, and depending on how the digital main rules are implemented.

As such, in some embodiments, the electronic document payload 179 is produced by the computer system 195 applying the certain M_RULE6 176, and in particular its certain consequent, as indicated by the arrow 178. In fact, sometimes applying the consequent is more simply stated as “applying the rule”.

In embodiments, an electronic document payload, such as electronic document payload 136, can be caused to be transmitted, e.g., via the network 188, by the computer system. The electronic document payload 136 can be include or be comprised of the electronic document payload 136 in many different formats 179 (e.g., a human readable format and a technical format). In the example of FIG. 1, electronic document payload 136 can be caused to be transmitted by the computer system 195, for example as an answer or other response to the received dataset 135. The electronic document payload 136 can also include data indicating that it has been determined, where it can be found, what it is, or at least a portion or a statistic of its content, and so on. Of course, the planning should be that the recipient of the electronic document payload 136 understands what it is being provided.

In embodiments, a certain one of the digital main rules may be identified from among the accessed stored rules by the computer system 195. In particular, values of the dataset 135 can be tested, according to arrows 171, against logical conditions of the digital main rules, as described later in this document. In this example, the certain main rule M_RULE6 176 is thus identified, which is indicated also by the beginning of an arrow 178 that is described in more detail later in this document. Identifying may be performed in a number of ways, and depending on how the digital main rules are implemented. An example is now described.

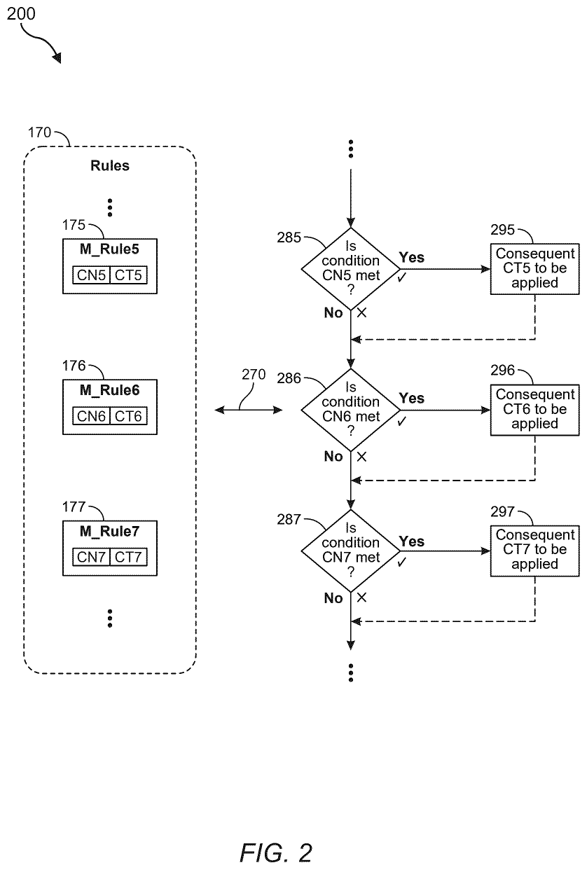

Referring now also to FIG. 2, some of the digital main rules of digital rules 170 are repeated from FIG. 1 in more detail. In addition, according to an arrow 270, these digital main rules are shown juxtaposed with a flowchart portion 200. In embodiments, some of the digital main rules can be expressed in the form of a logical “if-then” statement, such as: “if P then Q”. In such statements, the “if” part, represented by the “P”, is called the condition, and the “then” part, represented by the “Q”, is called the consequent. Therefore, at least some of the digital main rules include respective conditions and respective consequents associated with the respective conditions, respectively. And, for a certain digital main rule, if its certain condition P is met, then its certain consequent Q is what happens or becomes applied. One or more of the digital rules 170 may have more than one conditions P that both must be met, and so on. And some of these digital rules 170 may be searched for, and grouped, according first to one of the conditions, and then the other. In this example, the digital main rules M_RULE5 175, M_RULE6 176, and M_RULE7 177 of FIG. 1, include respective conditions CN5, CN6, CN7, and respective consequents CT5, CT6, CT7 associated with the respective conditions CN5, CN6, CN7, respectively.

In embodiments, therefore, identifying is performed by recognizing, by the computer system 195, that a certain condition of a certain one of the accessed digital main rules is met by one or more of the values of the dataset. An example of the operations of recognizing that a condition is met and thus identifying an applicable rule is shown by flowchart portion 200 of FIG. 2. According to successive decision diamonds 285, 286, 287, it is determined whether or not conditions CN5, CN6, CN7 are met by at least one of the values of the dataset, respectively. If the answer is NO, then execution may proceed to the next diamond. If the answer is YES then, according to operations 295, 296, 297, it is further determined that the respective consequents CT5, CT6, CT7 are to be applied, and then execution may proceed to the next diamond in the flowchart portion. A consequent that is to be applied could be, for example, flagged as TRUE.

From what was mentioned in connection with FIG. 1, the certain M_RULE6 176 was thus identified. With reference to FIG. 2, the identification may have happened at operation 286 of the flowchart portion 200, at which time it was recognized that condition CN6 was met by a value of the dataset 135. This made: the condition CN6 be the certain condition, the digital main rule M_RULE6 176 be the certain digital main rule, and the consequent CT6 be the certain consequent of the certain digital main rule M_RULE6 176. And the certain consequent CT6 is associated with the certain condition CN6, since both are included by the certain digital main rule 176. Therefore, according to operation 296, consequent CT6 is what happens or becomes applied, as described in connection with FIG. 1.

A number of examples are possible for how to recognize that a certain condition of a certain digital rule is met by at least one of the values of the dataset. For instance, the certain condition could define a boundary of a region that is within a space. The region could be geometric, and be within a larger space and may include political boundaries. For example, the region could be geographic, within the space of a city, a county, a state, a country, a continent or the earth. The boundary of the region could be defined in terms of numbers according to a coordinate system within the space. In the example of geography, the boundary could be defined in terms of groups of longitude and latitude coordinates. In such embodiments, the certain condition could be met responsive to the characterized attribute of the dataset being in the space and within the boundary of the region instead of outside the boundary. For instance, the attribute could be a location of the entity, and the one or more values of the dataset 135 that characterize the location could be one or more numbers or an address, or longitude and latitude. The condition can be met depending on how the one or more values compare with the boundary. For example, the comparison may reveal that the location is in the region instead of outside the region. The comparison can be made by rendering the characterized attribute in units comparable to those of the boundary. For example, the characterized attribute could be an address that is rendered into longitude and latitude coordinates, and so on.

Another example for how to recognize that a certain condition of a certain digital rule is met by at least one of the values of the dataset may involve analyzing prompt data to identify specific requirements for electronic document generation. For instance, the condition may involve identifying whether the prompt data includes sufficient information about a first entity, a second entity, and relationship instance details to generate a domain-compatible electronic document. In such cases, the condition may be met if the dataset includes all required elements properly identified and segregated.

The above embodiments are only examples, and not limiting. For instance, the example of FIG. 2 suggests that there is a one-to-one correspondence of the conditions with the associated consequents, but that is not necessary. In fact, a single consequent may be associated with two or more conditions, and two or more consequents may be associated with a single condition. Of course, all such can be shown as additional rules, with groups of them having the same condition or consequent.

For another instance, once it is determined that a consequent is to be applied, execution may even exit the flowchart portion 200. Or, as shown, it may be determined that more than one of the digital main rules is to be applied. In particular, operation 286 may give the answer YES such that consequent CT6 is to be applied, and operation 287 may also give the answer YES such that consequent CT7 is to be applied.

Where more than one of the digital main rules are found that could be applied, there are additional possibilities. For instance, the computer system 195 of FIG. 1 may further access at least one stored digital precedence rule, such as P_RULE2 172 or P_RULE3 173. Accordingly, the certain digital main rule may be thus identified also from the digital precedence rule. In particular, the digital precedence rule may decide which one or more of the digital main rules is to be applied. To continue the previous example, if a value of the dataset 135 that characterizes a location, and the location is within multiple overlapping regions according to multiple rules, the digital precedence rule may decide that all of them are to be applied, or less than all of them are to be applied. Equivalent embodiments are also possible, where digital precedence rules are applied first to limit the iterative search of the flowchart portion 200, so as to test the applicability of fewer than all the rules according to arrows 171.

In some embodiments, digital rules 170 may govern how the electronic document payload generator 183 processes different types of prompt data to generate appropriate domain-compatible electronic documents. For example, a rule may specify how to map first entity information, second entity information, and relationship instance information to appropriate document structures according to domain-specific requirements. These rules may also determine which AI models should be employed for different document generation scenarios, and how the resulting documents should be validated against domain requirements.

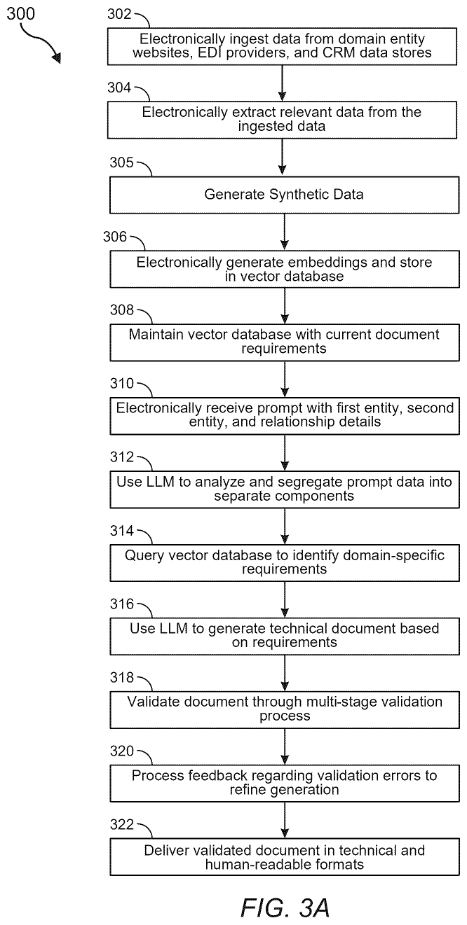

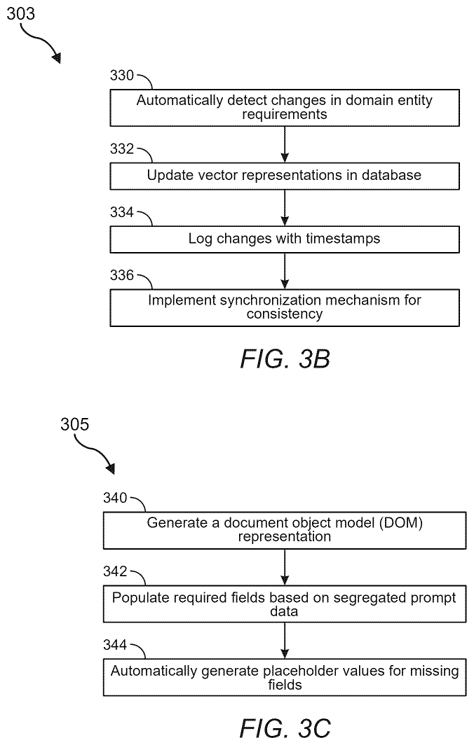

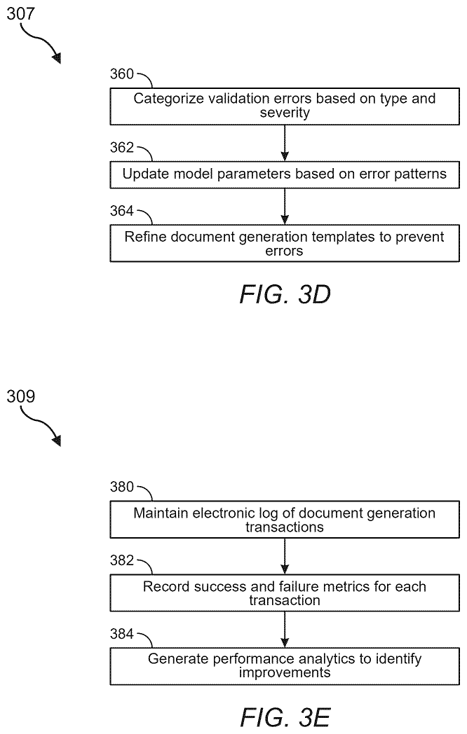

FIG. 3A is a flowchart illustrating a sample method 300 for domain-compatible electronic document generation according to embodiments of the present disclosure. The method 300 may be implemented by the system 102 of FIG. 1, and particularly by the electronic document payload generator 183 operating within the OSP 198.

In some embodiments, the method 300 may begin with electronically ingesting data from a plurality of data sources including domain entity websites, electronic data interchange (EDI) providers, and customer relationship management (CRM) data stores 302. This electronic ingestion process may involve interfacing with various types of data sources to obtain relevant information for document generation. The ingestion may be performed through automated web scraping mechanisms, API connections, or direct data transfers, enabling the system to gather up-to-date information about domain-specific requirements, entity information, and relationship data.

In some embodiments, the method 300 may proceed to electronically extract relevant data from the ingested data 304. This extraction process may involve identifying and isolating specific pieces of information that are necessary for electronic document generation, such as document structure specifications, validation rules, and domain-specific terminology. The extraction may employ sophisticated parsing algorithms that can recognize and extract structured data from various formats, including HTML, XML, JSON, and plain text sources.

In some embodiments, the method 300 may proceed to generate synthetic data 305. For example, the extracted data may flow to a synthetic data generation component, which refines and enriches the raw data. The synthetic data may be used to enhance training datasets, fill gaps in available information, and improve the system's ability to handle edge cases. In some embodiments, the synthetic data generation may employ machine learning techniques to create realistic but artificially generated examples that help train the model for situations not well-represented in the available real data.

In some embodiments, the method 300 may electronically generate embeddings based on the extracted and synthetic data and store the embeddings in a vector database 306. This process transforms the extracted text data into mathematical representations in a high-dimensional vector space, where semantically similar concepts are positioned close to each other. These embeddings may capture subtle relationships between terms and concepts, enabling more sophisticated matching and analysis during document generation. The vector database may store these embeddings in an optimized format that facilitates efficient similarity searches and retrieval.

In some embodiments, the method 300 may maintain the vector database with current electronic document requirements for multiple domains 308. This maintenance process may involve regular updates to ensure that the stored embeddings accurately reflect the latest document requirements across different domains. The system may monitor for changes in requirements through automated checks of authoritative sources and update the corresponding vector representations accordingly. This continuous maintenance may help ensure that generated documents remain compatible with evolving domain standards.

In some embodiments, the method 300 may electronically receive a prompt from a user device, the prompt including information about a first entity, a second entity, and relationship instance details 310. This prompt may come through a user interface that guides users to provide necessary information in a structured manner, or it may be received through an API call from another system. The prompt may include various details about the entities involved in a relationship instance, such as identifiers, locations, and specific characteristics of their relationship.

In some embodiments, the method 300 may use a large language model (LLM) to electronically analyze and segregate the prompt data into separate components 312. This analysis may decompose the prompt into distinct categories of information, isolating first entity information, second entity information, and relationship instance information. The LLM may apply contextual understanding to correctly categorize ambiguous information and ensure that all details are properly segregated for subsequent processing.

In some embodiments, the method 300 may electronically query the vector database using the segregated prompt data to identify domain-specific requirements applicable to the relationship instance 314. This query process may involve comparing the vector representations of the prompt data with stored embeddings of domain requirements to identify the most relevant matches. The system may consider multiple factors in this matching process, including the domains associated with both entities, the nature of their relationship, and any specific jurisdictional considerations that may apply. In an example embodiment, the system may use a nearest-neighbor algorithm to match prompt elements with corresponding document components based on vector similarity.

In some embodiments, the method 300 may use the LLM to electronically generate a technical document based on the segregated prompt data and the identified domain-specific requirements 316. This generation process may involve constructing a structured document that incorporates all necessary elements according to the identified requirements. The LLM may generate appropriate content for each section of the document, ensuring that all required fields are populated with accurate information derived from the prompt data. The generation process may also include applying specific formatting and structural elements required by the domain.

In some embodiments, the method 300 may electronically validate the generated technical document through a multi-stage validation process 318. This validation may include structural validation to verify that the document conforms to expected XML Schema Definitions (XSDs) or other structural specifications, domain-specific rule validation to check compliance with business rules encoded in a rule-based validation language (Schematron) or similar validation languages, and domain entity response validation to verify compatibility with receiving systems. Each stage of validation may provide specific feedback about any identified issues, enabling targeted corrections.

In some embodiments, the method 300 may use the LLM to electronically process feedback regarding validation errors to refine subsequent document generation 320. This feedback processing may involve analyzing error patterns to identify underlying causes and adjust generation parameters accordingly. The LLM may learn from these errors to improve its document generation capabilities over time, reducing the frequency of similar errors in future documents. This continuous improvement process may enhance the overall accuracy and efficiency of the document generation system.

In some embodiments, the method 300 may conclude with electronically delivering the validated document to the user device in both technical format and human-readable format 322. This delivery may provide users with both a machine-processable version of the document (such as XML) for submission to automated systems and a human-readable version (such as PDF) for review and record-keeping. The delivery may include annotations or highlighting to help users understand the correspondence between elements in both formats, making it easier to verify document contents before submission.

Throughout the method 300, the system may maintain detailed logs of processing steps, validation results, and delivery status to provide transparency and accountability. These logs may be valuable for troubleshooting, audit purposes, and continuous improvement of the document generation process. The method may also incorporate various security measures to protect sensitive information contained in the documents, such as encryption during storage and transmission, access controls, and digital verification mechanisms.

This method 300 represents a sophisticated approach to domain-compatible electronic document generation that leverages advanced AI technologies while maintaining rigorous validation against domain-specific requirements. By combining LLM capabilities with structured data processing and comprehensive validation, the method may enable more accurate and efficient generation of complex electronic documents across multiple domains.

FIG. 3B is a flowchart illustrating a sample method 303 for maintaining a vector database with current electronic document requirements according to embodiments of the present disclosure. The method 303 provides a detailed view of the operations performed in step 308 of FIG. 3A.

In some embodiments, the method 303 may begin with automatically detecting changes in domain entity requirements 330. This detection process may involve regular monitoring of authoritative sources through automated web scraping, API calls, or notification subscriptions. The system may scan for updates to document schemas, validation rules, or other requirements that could affect document compatibility. This proactive monitoring may help ensure that the document generation system remains current with evolving domain standards.

In some embodiments, the method 303 may proceed to update corresponding vector representations in the vector database 332. When changes are detected, the system may generate new embeddings for the updated requirements and modify the vector database accordingly. This update process may involve creating new vector representations that capture the semantic meaning of the changed requirements while maintaining the overall structure of the vector space. The update process may be designed to minimize disruption to ongoing operations while ensuring that new requirements are properly incorporated.

In some embodiments, the method 303 may log the changes with timestamps to maintain a historical record 334. This logging process may create a detailed audit trail of requirement changes, recording not only the nature of each change but also when it occurred. These timestamps may be valuable for understanding the evolution of requirements over time and for correlating changes with specific document versions. The historical record may also support rollback operations if needed, allowing the system to revert to previous requirement versions in case of errors or issues with new updates.

In some embodiments, the method 303 may implement a synchronization mechanism that facilitates consistency between the vector database and current domain entity requirements 336. This synchronization mechanism may employ various techniques to ensure that the vector representations accurately reflect the current state of domain requirements. The mechanism may include verification processes that compare vector representations against source requirements, identification of discrepancies, and automated correction procedures. This synchronization may occur on a scheduled basis or in response to detected changes, depending on the criticality of maintaining up-to-date representations.

FIG. 3C is a flowchart illustrating a sample method 305 for generating a technical document using a large language model (LLM) according to embodiments of the present disclosure. The method 305 provides a detailed view of step 316 of method 300.

In some embodiments, the method 305 may begin with generating a document object model (DOM) representation of the technical document 340. This initial step establishes the structural framework for the document, defining the hierarchical organization of elements according to domain requirements. The DOM representation may serve as a blueprint for how different components of the document will be organized and related to each other, ensuring that the final document adheres to expected structural patterns for its domain.

In some embodiments, the method 305 may proceed to populating required fields based on the segregated prompt data 342. Using the information that was previously segregated into distinct components (first entity information, second entity information, and relationship instance information), the system may insert appropriate values into the corresponding fields defined in the DOM. This population process may ensure that each required element of the document contains the correct information from the prompt data, maintaining the semantic connections between the prompt and the resulting document.

In some embodiments, the method 305 may automatically generate placeholder values for any missing required fields 344. When the segregated prompt data does not contain all information required by the document structure, the system may create appropriate provisional values to ensure document completeness. These placeholder values may be clearly marked to indicate their provisional nature, enabling users to identify and address information gaps before final submission. The generation of placeholders may help maintain structural integrity while highlighting areas that require additional attention or information.

The method 305 represents a core aspect of the document generation process, transforming structured prompt data into a complete technical document. By combining DOM-based structural organization with intelligent field population and placeholder generation, the method may produce documents that meet domain requirements while accurately reflecting the information provided in the prompt. This structured generation approach may significantly enhance the technical correctness and usability of the resulting electronic documents.

FIG. 3D is a flowchart illustrating a sample method 307 for processing validation feedback to refine document generation according to embodiments of the present disclosure. The method 307 provides a detailed view of operations of step 320 of method 300, which describes using the LLM to electronically process feedback regarding validation errors.

In some embodiments, the method 307 may begin with categorizing validation errors based on error type and severity 360. This categorization process may organize identified issues according to their nature (such as structural errors, content issues, or formatting problems) and their importance (from critical errors that prevent document acceptance to minor suggestions for improvement). This structured organization of validation feedback may provide a clear framework for addressing issues in order of priority and for recognizing patterns across multiple validations.

In some embodiments, the method 307 may proceed to updating model parameters based on error patterns 362. The system may analyze the categorized errors to identify recurring issues that suggest opportunities for improvement in the document generation process. Based on this analysis, the system may adjust parameters that control how the LLM generates document content, such as modifying prompt structures, adjusting weighting factors, or refining classification thresholds. These parameter updates may help reduce the frequency of similar errors in future documents, gradually improving generation quality over time.

In some embodiments, the method 307 may refine document generation templates to prevent recurring errors 364. Beyond adjusting model parameters, the system may modify the structural templates and pattern libraries used during document generation. These refinements may incorporate knowledge gained from validation errors, addressing specific structural or formatting issues that have been identified during validation. The template refinements may provide more robust patterns for future document generation, helping to avoid known pitfalls and improve overall document quality.

The method 307 represents an important feedback loop in the document generation system, enabling continuous improvement based on validation results. By systematically analyzing validation errors and applying the resulting insights to refine both model parameters and document templates, the method may progressively enhance the quality and accuracy of generated electronic documents. This continuous improvement process may significantly increase the effectiveness and efficiency of the electronic document generation system over time.

FIG. 3E is a flowchart illustrating a sample method 309 for maintaining transaction logs and generating performance analytics according to embodiments of the present disclosure.

In some embodiments, the method 309 may begin with maintaining an electronic log of document generation transactions 380. This logging process may create detailed records of each document generation event, including information about the prompt data received, processing steps applied, validation results, and delivery status. These comprehensive logs may provide a complete history of system activity, supporting various operational and analytical functions. The transaction logs may be structured to facilitate efficient querying and analysis while ensuring complete recordkeeping for compliance and operational purposes.

In some embodiments, the method 309 may record success and failure metrics for each transaction 382. Beyond basic transaction details, the system may capture specific metrics that indicate the performance and effectiveness of each document generation attempt. These metrics may include validation pass rates, error frequencies by category, processing times, and user interaction patterns. The recorded metrics may provide quantitative insights into system performance, highlighting both successes and areas for improvement. This detailed performance data may support both operational monitoring and strategic electronic improvement initiatives.

In some embodiments, the method 309 may generate performance analytics to identify improvement opportunities 384. Using the recorded success and failure metrics, the system may perform various analytical processes to discover patterns, trends, and correlations that suggest potential improvements. These analytics may include statistical analyses of error rates across different document types, temporal patterns in processing times, and correlations between prompt characteristics and validation outcomes. The resulting insights may reveal specific opportunities to enhance system performance, either through targeted refinements or broader architectural improvements.

The method 309 represents a monitoring and improvement framework for the document generation system. By maintaining detailed transaction logs, recording comprehensive performance metrics, and applying sophisticated analytics to identify improvement opportunities, the method may support continuous enhancement of system capabilities and effectiveness. This data-driven approach to system management may significantly contribute to the long-term quality, reliability, and efficiency of the electronic document generation process.

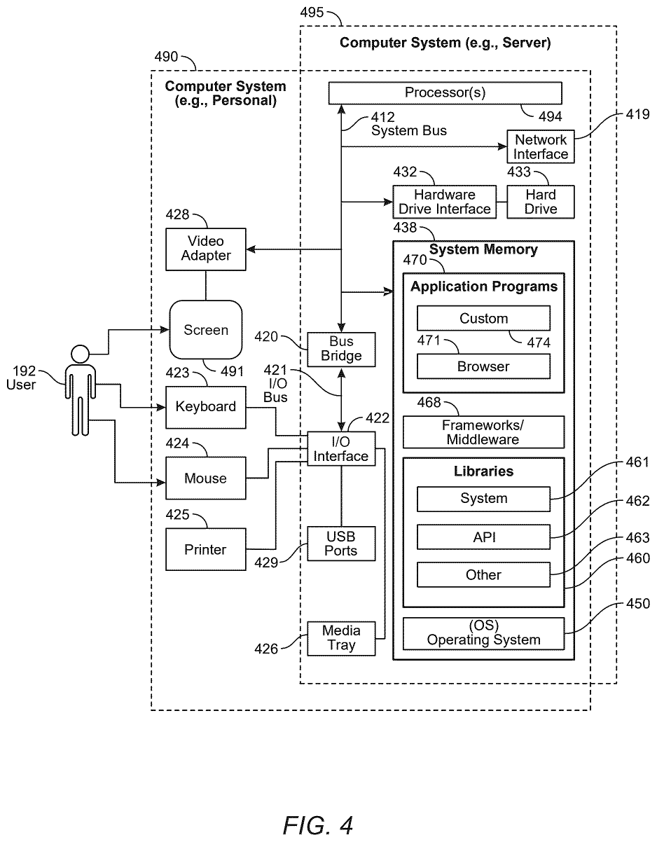

FIG. 4 is a block diagram showing additional components of sample computer systems according to embodiments of the present disclosure. FIG. 4 shows details for a sample computer system 495 and for a sample computer system 490. The computer system 495 may be a server, while the computer system 490 may be a personal device, such as a personal computer, a desktop computer, a personal computing device such as a laptop computer, a tablet computer, a mobile phone, and so on. Either type may be used for the computer system 195 and 190 of FIG. 1, a computer system that is part of OPF 189 and/or a computer system that is part of any entity or system shown in any of the Figures of the present disclosure.

The computer system 495 and the computer system 490 have similarities, which FIG. 4 exploits for purposes of economy in this document. It will be understood, however, that a component in the computer system 495 may be implemented differently than the same component in the computer system 490. For instance, a memory in a server may be larger than a memory in a personal computer, and so on. Similarly, custom application programs 474 that implement embodiments may be different, and so on.

The computer system 495 includes one or more processors 494. The processor(s) 494 are one or more physical circuits that manipulate physical quantities representing data values. The manipulation can be according to control signals, which can be known as commands, op codes, machine code, etc. The manipulation can produce corresponding output signals that are applied to operate a machine. As such, one or more processors 494 may, for example, include a Central Processing Unit (CPU), a Reduced Instruction Set Computing (RISC) processor, a Complex Instruction Set Computing (CISC) processor, a Graphics Processing Unit (GPU), a quantum processor or computer, a Digital Signal Processor (DSP), a Field-Programmable Gate Array (FPGA), an Application Specific Integrated Circuit (ASIC), any combination of these, and so on. A processor may further be a multi-core processor having two or more independent processors that execute instructions to perform functionality described herein concurrently and/or simultaneously. Such independent processors are sometimes called “cores.”

A hardware component such as a processor may also include programmable logic or circuitry that is temporarily configured by software to perform certain operations. For example, a hardware component may include software executed by a general-purpose processor or another type of programmable processor. Once configured by such software, hardware components become specific specialized machines, or specific specialized components of a machine, uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

As used herein, a “component” may refer to a device, physical entity or logic having boundaries defined by function or subroutine calls, branch points, Application Programming Interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. The hardware components depicted in the computer system 495, or the computer system 490, are not intended to be exhaustive. Rather, they are representative, for highlighting components that can be used with embodiments.

The computer system 495 also includes a system bus 412 that is coupled to the processor(s) 494. The system bus 412 can be used by the processor(s) 494 to control and/or communicate with other components of the computer system 495.

The computer system 495 additionally includes a network interface 419 that is coupled to system bus 412. Network interface 419 can be used to access a communications network, such as the network 188. Network interface 419 can be implemented by a hardware network interface, such as a Network Interface Card (NIC), wireless communication components, cellular communication components, Near Field Communication (NFC) components, Bluetooth® components such as Bluetooth® Low Energy, Wi-Fi® components, etc. Of course, such a hardware network interface may have its own software, and so on.

The computer system 495 also includes various memory components. These memory components include memory components shown separately in the computer system 495, plus cache memory within the processor(s) 494. Accordingly, these memory components are examples of non-transitory machine-readable media. The memory components shown separately in the computer system 495 are variously coupled, directly or indirectly, with the processor(s) 494. The coupling in this example is via the system bus 412.

Instructions for performing any of the methods or functions described in this document may be stored, completely or partially, within the memory components of the computer system 495, etc. Therefore, one or more of these non-transitory computer-readable media can be configured to store instructions which, when executed by one or more processors 494 of a host computer system such as the computer system 495 or the computer system 490, can cause the host computer system to perform operations according to embodiments. The instructions may be implemented by computer program code for carrying out operations for aspects of this disclosure. The computer program code may be written in any combination of one or more programming languages, including an object-oriented programming language such as Java, Python, Smalltalk or the like, and/or conventional procedural programming languages, such as the “C” programming language or similar programming languages such as C++, C Sharp, etc.

The memory components of the computer system 495 include a non-volatile hard drive 433. The computer system 495 further includes a hard drive interface 432 that is coupled to the hard drive 433 and to the system bus 412.

The memory components of the computer system 495 include a system memory 438. The system memory 438 includes volatile memory including, but not limited to, cache memory, registers and buffers. In embodiments, data from the hard drive 433 populates registers of the volatile memory of the system memory 438.

In some embodiments, the system memory 438 has a software architecture that uses a stack of layers, with each layer providing a particular functionality. In this example the layers include, starting from the bottom, an Operating System (OS) 450, libraries 460, frameworks/middleware 468 and application programs 470, which are also known as applications 470. Other software architectures may include less, more or different layers. For example, a presentation layer may also be included. For another example, some mobile or special purpose operating systems may not provide a frameworks/middleware 468.

The OS 450 may manage hardware resources and provide common services. The libraries 460 provide a common infrastructure that is used by the applications 470 and/or other components and/or layers. The libraries 460 provide functionality that allows other software components to perform tasks more easily than if they interfaced directly with the specific underlying functionality of the OS 450. The libraries 460 may include system libraries 461, such as a C standard library. The system libraries 461 may provide functions such as memory allocation functions, string manipulation functions, mathematical functions, and the like. In some embodiments, the computer program code may also be written, and software deployed, using a microservice architecture, which structures an application as a collection of services and/or containerization that that bundles an application's code with all the files and libraries it needs to run on any infrastructure. For example, the Kubernetes® open source tool may be used to automate the deployment, scaling, and management of containers without launching virtual machines for any applications.

In addition, the libraries 460 may include API libraries 462 and other libraries 463. The API libraries 462 may include media libraries, such as libraries to support presentation and manipulation of various media formats such as MPEG4, H.264, MP3, AAC, AMR, JPG, and PNG. The API libraries 462 may also include graphics libraries, for instance an OpenGL framework that may be used to render 2D and 3D in a graphic content on the screen 491. The API libraries 462 may further include database libraries, for instance SQLite, which may support various relational database functions. The API libraries 462 may additionally include web libraries, for instance WebKit, which may support web browsing functionality, and also libraries for applications 470 or for any software component, module, model or platform described herein.

The frameworks/middleware 468 may provide a higher-level common infrastructure that may be used by the applications 470 and/or other software components/modules. For example, the frameworks/middleware 468 may provide various Graphic User Interface (GUI) functions, high-level resource management, high-level location services, and so forth. The frameworks/middleware 468 may provide a broad spectrum of other APIs that may be used by the applications 470 and/or other software components/modules, some of which may be specific to the OS 450 or to a platform.

The application programs 470 are also known more simply as applications and apps. One such app is a browser 471, which is a software that can permit the user 192 to access other devices over the internet, for example while using a Graphic User Interface (GUI). The browser 471 includes program modules and instructions that enable the computer system 495 to exchange network messages with a network, for example using Hypertext Transfer Protocol (HTTP) messaging.

The application programs 470 may include one or more custom applications 474, made according to embodiments. These can be made so as to cause their host computer to perform operations according to embodiments disclosed herein. Of course, when implemented by software, operations according to embodiments disclosed herein may be implemented much faster than may be implemented by a human mind if they can be implemented in the human mind at all; for example, tens or hundreds of such operations may be performed per second according to embodiments, which is much faster than a human mind can do. Such speed of operations, and thus the use of such computing systems and networks, are integral to the embodiments described herein because such operations would be practically useless unless they are able to be applied to hundreds or thousands of computer network clients simultaneously or concurrently across computer networks and to the vast volumes of data that change in real-time provided by such computer network clients. Implementing a practical application of the embodiments described herein to hundreds or thousands of computer network clients simultaneously or concurrently across computer networks on which they operate and to the vast volumes of data that change in real-time provided by such computer network clients is impossible to do in the human mind.

Other such applications 470 may include a contacts application, a social media application, a customer relationship management (CRM) application, an EDI application, an ERP application, a word processing application, an electronic data interchange (EDI) system, a location application, a media application, a messaging application, and so on. Applications 470 may be developed using various software development kits (SDKS) (e.g., an artificial intelligence (AI) SDK, the ANDROID™ or IOS™ SDK, etc.) by an entity other than the vendor of the particular platform, and may be mobile software running on a mobile operating system such as IOS™, ANDROID™, or other mobile operating systems. The applications 470 may use built-in functions of the OS 450, of the libraries 460, and of the frameworks/middleware 468 to create user interfaces for the user 192 to interact with.

The computer system 495 moreover includes a bus bridge 420 coupled to the system bus 412. The computer system 495 furthermore includes an input/output (I/O) bus 421 coupled to the bus bridge 420. The computer system 495 also includes an I/O interface 422 coupled to the I/O bus 421.

For being accessed, the computer system 495 also includes one or more Universal Serial Bus (USB) ports 429. These can be coupled to the I/O interface 422. The computer system 495 further includes a media tray 426, which may include storage devices such as CD-ROM drives, multi-media interfaces, and so on.

The computer system 490 may include many components similar to those of the computer system 495, as seen in FIG. 4. In addition, a number of the application programs may be more suitable for the computer system 490 than for the computer system 495.

The computer system 490 further includes peripheral input/output (I/O) devices for being accessed by a user more routinely. As such, the computer system 490 includes a screen 491 and a video adapter 428 to drive and/or support the screen 491. The video adapter 428 is coupled to the system bus 412.

The computer system 490 also includes a keyboard 423, a mouse 424, and a printer 425. In this example, the keyboard 423, the mouse 424, and the printer 425 are directly coupled to the I/O interface 422. Sometimes this coupling is wireless or may be via the USB ports 429.

In this context, “machine-readable medium” or “computer-readable storage medium” refers to a component, device or other tangible media able to store instructions and data temporarily or permanently and may include, but is not be limited to: a thumb drive, a hard disk, random-access memory (RAM), read-only memory (ROM), buffer memory, flash memory, optical media, magnetic media, cache memory, an Erasable Programmable Read-Only Memory (EPROM), an optical fiber, a portable digital versatile disc (DVD), an optical storage device, a magnetic storage device, or any suitable combination of the foregoing. The machine that would read such a medium includes one or more processors 494.

The term “machine-readable medium” or “computer-readable storage medium” should be taken to include a single medium or multiple media (e.g., a centralized or distributed database, or associated caches and servers) able to store instructions that a machine such as a processor can store, erase, or read. Such a “computer-readable storage medium” may include a “non-transitory computer-readable storage medium”. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methods described herein. Accordingly, instructions transform a general or otherwise generic, non-programmed machine into a specialized particular machine programmed to carry out the described and illustrated functions in the manner described.

A computer readable signal traveling from, to, and via these components may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

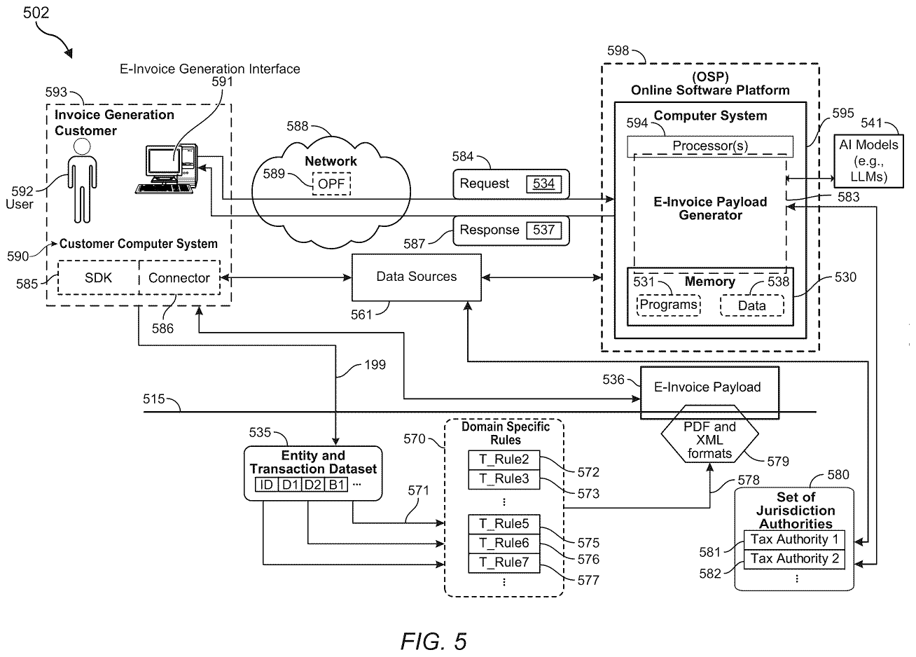

The computer system 495 and computer system 490 illustrated in FIG. 4 provide detailed implementations that may be used for various components shown in FIGS. 1 and 5. For example, the computer system 495 with its processors 494, memory 438, and network interface 419 may implement the server-side components of the OSP 198 shown in FIG. 1, including the electronic document payload generator 183 that applies the digital rules 170 to generate electronic document payloads 179. Similarly, the computer system 490 with its screen 491 and user interface components may correspond to the client device 593 in FIG. 5, providing the E-Invoice Generation Interface 591 through which users interact with the system. The custom applications 474 stored in application programs 470 may implement specific functionalities of both the electronic document payload generator 183 of FIG. 1 and the E-Invoice Payload Generator 583 of FIG. 5, including the data extraction module, vector database operations, and validation processes. The network interface 419 facilitates the bidirectional communication between the OSP and various external systems, including the domain entity websites, EDI providers, and CRM data stores shown as data sources 561 in FIG. 5, as well as the tax authorities 580 that receive the generated document payloads. This hardware architecture provides the computational foundation for the domain-compatible electronic document generation system described throughout the application, enabling the sophisticated AI-driven processes depicted in the logical architectures of FIGS. 1 and 5.

### Operational Examples—Use Cases

The above-mentioned embodiments have one or more uses. Aspects presented below may be implemented as was described above for similar aspects. (Some, but not all, of these aspects have even similar reference numerals.)

Use cases for the technological solutions disclosed herein can be in, but are not limited to, the fields of compliance, for example, tax or other business compliance with a government authority or any set of requirements. However, the possible use of such technological solutions disclosed herein in various practical fields does not make such solutions non-technical in nature or abstract ideas.

Businesses operating in today's global marketplace face significant challenges in navigating the complex landscape of electronic invoicing (e-invoicing) requirements across different jurisdictions. E-invoicing, the digital exchange of invoice documents between suppliers and buyers, has been increasingly mandated by tax authorities worldwide as they seek to reduce tax gaps, minimize fraud, and increase transparency in commercial transactions. However, the implementation of these e-invoicing mandates varies substantially across different countries and even regions within countries, creating a complex compliance environment that businesses must navigate.

The challenge of crafting jurisdiction-specific e-invoice payloads presents a multifaceted problem for businesses operating across multiple domains. Each tax authority may mandate specific technical formats, data requirements, validation rules, and submission protocols that must be precisely followed. For example, Italy's Sistema di Interscambio (SDI) requires invoices in FatturaPA XML format with specific validation rules, while Mexico's Comprobante Fiscal Digital por Internet (CFDI) employs different XML schemas with particular certification requirements. Even within the European Union, despite efforts toward standardization through PEPPOL and EN16931, individual member states maintain distinct technical implementations and regulatory nuances.

Non-compliance with these jurisdiction-specific requirements frequently leads to severe financial penalties that can significantly impact a business's bottom line. These penalties vary widely by jurisdiction but can be substantial, ranging from fixed amounts per incorrect invoice to percentages of the transaction value or even the total tax amount. In Italy, for instance, penalties for non-compliant e-invoices can reach up to 180% of the VAT amount in cases of tax evasion, while in Mexico, fines can amount to 55-75% of the omitted tax. Beyond direct financial penalties, businesses may face additional consequences such as delayed payments, rejected invoices requiring resubmission, interest charges, increased audit scrutiny, and potential damage to business relationships and reputation.

This compliance challenge is further exacerbated by the lack of comprehensive guidelines for regulatory obligations. Tax authorities often publish technical specifications across multiple documents, platforms, and formats, with many crucial implementation details buried in technical annexes, clarification notes, or FAQ sections that may not be regularly updated or easily accessible. Frequently, these specifications are only available in the local language, adding another layer of complexity for international businesses. Moreover, there is often a disconnect between the published specifications and the actual implementation requirements, with discrepancies discovered only during the validation or submission process after significant development effort has already been expended.

The process of understanding these rules and regulations is exceptionally time-consuming and requires specialized knowledge that represents an increasingly scarce resource. Businesses must dedicate significant time to researching jurisdiction-specific requirements, interpreting technical specifications, monitoring regulatory changes, and implementing compliant solutions. This research often involves navigating through government portals that may be poorly organized, technically outdated, or available only in local languages. The technical nature of these requirements demands expertise in both tax regulations and technical implementation standards, which is a combination of skills that is increasingly difficult to find and retain. Moreover, tax authorities frequently update their requirements, necessitating constant vigilance and adaptation.

For multi-jurisdictional businesses, dedicating resources for cross-jurisdictional compliance leads to deteriorating operational efficiency. Each new jurisdiction exponentially increases the compliance burden, as businesses must not only understand and implement each jurisdiction's requirements individually but also maintain multiple parallel systems or processes. This complexity is particularly challenging for smaller and medium-sized enterprises that lack dedicated compliance departments. The need to stay current with evolving requirements across multiple jurisdictions creates a continuous maintenance burden that diverts resources from core business activities. Furthermore, the technical nature of e-invoicing requirements often necessitates involvement from multiple departments, including finance, IT, legal, and operations, creating coordination challenges and potential bottlenecks.

Traditional approaches to addressing these challenges, such as hiring local experts for each jurisdiction or implementing separate systems for each set of requirements, quickly become unsustainable as businesses expand into new markets. Manual processes for generating compliant e-invoice payloads are not only labor-intensive but also prone to human error, potentially leading to rejected invoices, payment delays, and compliance issues. While some software solutions exist to address these challenges, they typically require substantial configuration for each jurisdiction, ongoing maintenance as requirements change, and often lack the flexibility to adapt quickly to regulatory updates.

The technical complexity of e-invoice requirements compounds these challenges. Different jurisdictions may specify different character encoding standards, namespace references, digital signature algorithms, validation mechanisms, and transmission protocols. Some require real-time communication with tax authority systems, while others allow batch processing. Validation rules can be intricate, involving complex interdependencies between different invoice fields, conditional requirements based on transaction types, and jurisdiction-specific business rules that must be precisely implemented.

Moreover, the rapid global expansion of e-invoicing mandates means that businesses must now contend with an ever-growing number of jurisdictions implementing new requirements. According to industry reports, more than 60 countries now have some form of e-invoicing requirement, with this number expected to exceed 100 within the next five years. Many countries are also evolving their systems toward more sophisticated real-time or near-real-time reporting models, further increasing the technical complexity and compliance burden.

These challenges create a significant technological gap in the market. Traditional tax software approaches typically rely on hard-coded rules and manually configured templates that require frequent updates and maintenance. Such approaches struggle to scale efficiently across multiple rapidly evolving jurisdictions and often lack the flexibility to quickly adapt to regulatory changes. The resource-intensive nature of maintaining compliance across multiple jurisdictions creates substantial operational inefficiencies, particularly for businesses operating globally or expanding into new markets.

There is a clear need for a more sophisticated, scalable, and adaptive approach to generating jurisdiction-specific e-invoice payloads, in particular, one that can leverage modern artificial intelligence technologies to understand complex regulatory requirements, adapt quickly to changes, and generate compliant documents with minimal human intervention. Such a solution would need to address not only the technical complexity of e-invoice formats but also the contextual understanding required to correctly interpret regulatory requirements and apply them to specific business scenarios.

The invention described in this application addresses precisely these challenges through a novel application of large language models and domain-specific training to create a sophisticated system for domain-compatible electronic document generation that is particularly well-suited to the complexity of e-invoicing requirements. By combining advanced natural language processing capabilities with specialized training on tax regulations and technical specifications, the system provides a scalable, adaptable solution to the challenge of generating compliant e-invoice payloads across multiple jurisdictions, significantly reducing the compliance burden on businesses while improving accuracy and efficiency.

FIG. 5 is a diagram showing sample aspects of an invoice generation system 502 for jurisdiction-compliant electronic document generation in the specific context of e-invoicing according to embodiments of the present disclosure. The diagram illustrates how the general system architecture presented in FIG. 1 may be adapted and applied to the specific use case of generating e-invoice payloads that comply with the requirements of different tax authorities.

In this example embodiment, the invoice generation system 502 facilitates the creation of jurisdiction-compliant e-invoice payloads for an invoice generation customer 593, which may be a seller, for example. A user 592 associated with the invoice generation customer 593 may interact with the system through an E-Invoice Generation Interface 591 that provides a graphical user interface (GUI) for entering information and viewing results. Above a thick line 515, which separates the diagram into two portions, are depicted the primary entities, components, and their relationships. Below the line 515, the emphasis is on the data processing that typically occurs within these components.

The system 502 includes a computer system 595 that implements an E-Invoice Payload Generator 583 as part of an Online Software Platform (OSP). The computer system 595 includes one or more processors 594 and memory 530 containing programs 531 and data 538. In some embodiments, the computer system 595 may be one of many computer systems implementing the OSP 598, such as those in a data center or cloud-based computing system. The memory 530 may store digital rules specifically tailored for e-invoice generation, including tax rules T_RULE5 575, T_RULE6 576, and T_RULE7 577, as well as precedence rules T_RULE2 572 and T_RULE3 573, which govern how different rules should be applied when multiple rules might apply to a particular scenario. The memory 530 may in some embodiments be cloud storage and also store data extracted from data sources 561, creating a comprehensive knowledge base for the e-invoicing system.

In some embodiments, the computer system 595 may communicate with AI Models 541, such as large language models (LLMs) or other types of AI systems, to assist with e-invoice payload generation. These AI Models 541 may analyze prompts and requirements from various jurisdictions to generate appropriate structured documents that comply with specific jurisdiction requirements.

The user 592 associated with the invoice generation customer 593 may interact with the system through a computer system 590 that displays the E-Invoice Generation Interface 591 and has (or has access to) a Software Development Kit (SDK) 585 and a connector 586 for communicating with the OSP 598. The SDK 585 provides tools and libraries that enable the computer system 590 to properly format requests, while the connector 586 may facilitate the transmission of requests 584 containing payloads with information needed for e-invoice generation. These requests may be sent over a communication network 588 to the computer system 595, which processes them and returns responses 587 containing generated e-invoice payloads 536 in appropriate formats. The responses may be displayed to the user 592 via the E-Invoice Generation Interface 591.

The system 502 may connect to and ingest data from various data sources 561, which may include tax authority websites, electronic data interchange (EDI) providers, customer relationship management (CRM) data stores, and other relevant sources. These data sources 561 provide critical information about jurisdiction-specific requirements, formatting specifications, validation rules, and other elements necessary for generating compliant e-invoice payloads.

In some embodiments, the system 502 may produce e-invoice payloads in multiple formats as required by different tax authorities. As shown in the diagram, the system may generate both PDF and XML formats 579 of the e-invoice, as these are commonly required formats for different tax compliance scenarios. The PDF format may provide a human-readable version of the invoice for review and record-keeping, while the XML format may contain the structured data required for automated processing by tax authority systems, such as those in the set of jurisdiction authorities 580. These different formats may be displayed or made available to the user 592 through the E-Invoice Generation Interface 591.

Below the line 515, the diagram shows an entity and transaction dataset 535 that includes various values characterized by an identifier (ID), entity data (D1, D2), and potentially a base value (B1) among other elements. This dataset may represent information about the entities involved in the transaction, the nature of the goods or services being invoiced, pricing details, tax rates, and other information necessary for generating an accurate and compliant e-invoice. The entity and transaction dataset 535 may be extracted from the payload 534 of the request 584 received from the invoice generation customer's computer system 590, potentially including data entered by the user 592 through the E-Invoice Generation Interface 591.

The system 502 applies the digital tax rules 570 to this dataset to determine the appropriate structure, content, and format for the e-invoice based on the applicable jurisdiction. These rules may specify requirements such as mandatory fields, validation rules, calculation methods for tax amounts, and formatting specifications that must be followed to ensure compliance with the relevant tax authority's requirements.

The application of these rules results in the generation of an e-invoice payload 536 that can be transmitted back to the invoice generation customer 593 and/or submitted directly to the appropriate tax authorities, such as Tax Authority 1 581 and Tax Authority 2 582. Shown are connections to a set of jurisdiction authorities 580, including Tax Authority 1 581 and Tax Authority 2 582, indicating that the system 502 may be capable of generating e-invoices compliant with the requirements of multiple tax jurisdictions and potentially submitting them directly to the relevant authorities on behalf of the invoice generation customer 593. For example, the set of jurisdiction authorities 580, including tax authorities such as Tax Authority 1 581 and Tax Authority 2 582, may digitally provide authoritative regulatory requirements and receive submitted e-invoice payloads. These authorities maintain various electronic systems, APIs, web portals, and documentation repositories that the system 502 may interact with bidirectionally. Through secure communication channels established over network 588 or other connections, the system 502 may periodically connect to these authorities'systems to retrieve updated technical specifications, validation rules, XML schemas, structural schema based on a rule-based validation language (e.g., schematrons), and regulatory changes that are stored as part of or communicated to data sources 561 to be stored there. This ingestion process may use web scraping mechanisms, API connections, or official data feeds depending on each jurisdiction's available interfaces. Simultaneously, the E-Invoice Payload Generator 583 may submit finalized e-invoice payloads 536 to these authorities'submission endpoints, often using authority-specific authentication methods, digital signatures, and transmission protocols. The systems of Tax Authority 1 581 and Tax Authority 2 582 may respond with validation results, acceptance confirmations, or error messages that flow back through the OSP 598 to provide feedback for continuous improvement. Some tax authorities may also maintain test endpoints that the system may leverage for pre-validation before actual submission, enabling the detection and correction of potential compliance issues without triggering penalties or delays. This bidirectional communication channel between the system 502 and the set of jurisdiction authorities 580 forms a technical infrastructure component that enables a practical application of real-time compliance with constantly evolving regulatory requirements across multiple tax jurisdictions.

In some embodiments, the system may leverage an Online Processing Facility (OPF) 589 that provides additional processing capabilities or services. This might include services such as digital signature application, secure storage of e-invoices, or integration with other business systems used by the invoice generation customer.

This implementation of jurisdiction-compliant electronic document generation specifically for e-invoicing represents a practical application of the general technique described in earlier figures, demonstrating how the system may be adapted to address particular compliance challenges in the tax domain. The system's ability to generate correctly formatted and compliant e-invoices across multiple jurisdictions may substantially improve operational efficiency for computer systems providing such services while reducing compliance risks. The technical improvements provided by the system 502 in the e-invoicing use case include significant reductions in processing time for generating compliant e-invoices (from hours or days to seconds), dramatic decreases in error rates through automated validation against current jurisdiction requirements, and substantial resource conservation through the elimination of redundant parallel compliance systems. For businesses operating across multiple jurisdictions, the system may reduce computational resource requirements compared to maintaining separate compliance systems for each jurisdiction, while simultaneously increasing throughput capacity to thousands of e-invoices per hour across diverse jurisdictional requirements.

The following figures illustrate specific processes and algorithms implemented by the system for jurisdiction-compliant e-invoice generation. These illustrations depict examples of detailed operational components, including data extraction and synthetic data generation, document model creation, user interaction flows, payload generation processes, multi-stage validation procedures, and feedback mechanisms that enable continuous improvement of the computerized system. Together, these processes form a technical framework that addresses the complex technical challenges of cross-jurisdictional e-invoice compliance while providing business computing systems with an efficient, scalable solution.

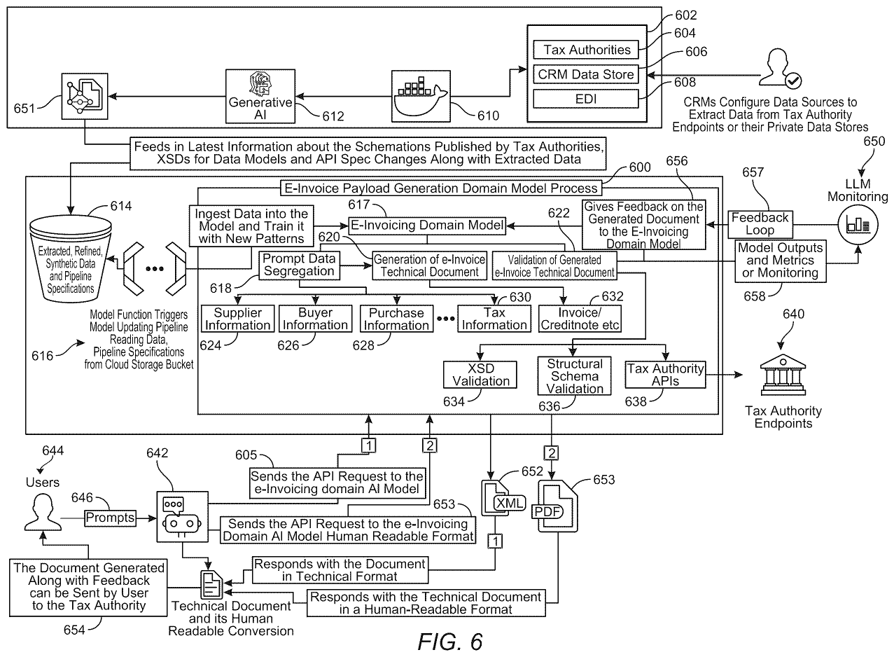

FIG. 6 shows an example diagram illustrating the E-Invoice Payload Generation Domain Model Process 600 of a Generative AI-powered E-Invoice Payload Generator system. The diagram illustrates how users interact with the system to generate compliant electronic invoice documents and the underlying processes that support this functionality.

In some embodiments, the E-Invoice Payload Generator Chatbot 642 may serve as the primary user interface through which Users 644 may interact with the system. The E-Invoice Payload Generator Chatbot 642 provides an intuitive, conversational interface that allows users to request e-invoice generation without requiring detailed technical knowledge of the underlying document formats or domain-specific requirements. Users 644 may enter Prompts 646 into the E-Invoice Payload Generator Chatbot 642 with varying levels of detail. For example, a user might enter:
“Invoice INV-101 from Finastra (4 Kingdom St, London, EC1Y 8SY, UK, Endpoint ID: 153456789, Scheme ID: 9935, VAT number: 888654321) to Avalara Inc. (Lancaster House, Brighton, BN1 4FU, UK, Endpoint ID: AVALARATEST, Scheme ID: 9930, Company ID: 1234569), contact Andrea Flamini (Phone: 23435421, Email: andrea@avalara.com), with payment via bank transfer (IBAN: IBAN 32423940, BIC: BIC324032398BIC 32423), for 2 bottles of water @£2 each (VAT 19%) and 5 apples @£1 each (VAT 7%), requesting a UBL 2.1 XML e-invoice.”

In some embodiments, the E-Invoice Payload Generator Chatbot 642 may also support more complex requests that include generation and submission in a single prompt, such as:
“Invoice INV-101 from Finastra (4 Kingdom St, London, EC1Y 8SY, UK, Endpoint ID: 153456789, Scheme ID: 9935, VAT number: 888654321) to Avalara Inc. (Lancaster House, Brighton, BN1 4FU, UK, Endpoint ID: AVALARATEST, Scheme ID: 9930, Company ID: 1234569), contact Andrea Flamini (Phone: 23435421, Email: andrea@avalara.com), with payment via bank transfer (IBAN: IBAN 32423940, BIC: BIC324032398BIC 32423), for 2 bottles of water @£2 each (VAT 19%) and 5 apples @£1 each (VAT 7%), requesting the generation and submission of an E-Invoice in UBL 2.1 XML format.”

In some embodiments, when the E-Invoice Payload Generator Chatbot 642 receives a prompt from a user, it may send two different API requests to the E-Invoicing domain model 617. The first API request 605 may be for generating the document in technical format, which may include formats such as XML, JSON, EDI X12, or EDIFACT that are suitable for electronic processing and submission to tax authorities. The second API request 653 may be for generating the Human Readable Conversion of the same document, which may include formats such as PDF, HTML, or formatted text documents that are easier for humans to read and understand. This dual-format technique may allow users to both submit the document electronically and maintain a human-readable record of the transaction.

The E-Invoicing domain model 617 represents a specialized e-invoicing domain model specifically engineered for the automated generation of e-invoicing payloads, ensuring a high level of accuracy. This domain model 617 may utilize self-supervised learning techniques with fine-tuned hyperparameters to reduce hallucination errors that might otherwise occur in generative AI systems. The E-Invoicing domain model 617 may have been trained extensively using authoritative schemas and XSDs for robust validation processes, which may enhance its ability to generate compliant documents across different jurisdictions. The E-Invoicing domain model 617 may employ algorithms that utilize embedding techniques for accurate data mapping and processing. This technique may enable the model to correctly map input data to the appropriate fields in the e-invoice document, even when the input data is provided in natural language format or contains variations in terminology or formatting.

In some embodiments, after receiving the user prompt, the E-Invoice Payload Generator Chatbot 642 initiates the e-invoice generation process by triggering the Prompt Data Segregation 618. This starts the process that leads to the creation of a compliant e-invoice document. The subsequent processing steps may all occur automatically without requiring further user input, although the system may request additional information if necessary data is missing from the original prompt.

In some embodiments, the process of generating an e-invoice payload involves receiving information from multiple data sources 602, including Tax Authorities 604, Customer Relationship Management (CRM) Data Store 606, and Electronic Data Interchange (EDI) 608. CRM systems are software applications that help businesses manage interactions with customers and store customer data, while EDI refers to the computer-to-computer exchange of business documents in a standard electronic format between business partners. These data sources 602 may provide important information needed for generating compliant electronic invoices across different jurisdictions. The CRMs may configure Data Sources 602 to extract data from Tax Authority endpoints 640 or their private data stores.

In some embodiments, an Data Extraction Module 610 may be implemented to monitor changes in the data sources 602. The Data Extraction Module 610 may continuously watch for changes in the data sources, extract newer data, and push it into the workflow. The Data Extraction Module 610 may monitor data sources, scrape changes in sources like guidelines, examples, structural schema (e.g., schematrons), XSDs, and API specifications from tax authorities, and extracts relevant data. This module 610 may feed in latest information about the structural schema (e.g., schematrons) published by tax authorities, XML Schema Definitions (XSDs) for data models, and API specification changes along with extracted data. Schematron is a rule-based validation language for making assertions about the presence or absence of patterns in XML trees. It is a structural schema language expressed in XML using a small number of elements and XPath languages. In many implementations, the Schematron XML is processed into Extensible Stylesheet Language Transformations (XSLT) code for deployment anywhere that XSLT can be used. XSDs are a way to define the structure, content, and semantics of XML documents, which may be used for e-invoice formats. However, other data structures or structural schema based on rule-based validation languages may be used.

The system may incorporate a Generative AI 612 that processes the data extracted by the Data Extraction Module 610. The Generative AI 612 may send the data to have useful pieces extracted and synthetic data generated therefrom data, or may itself perform the extraction of useful pieces and perform the generation of synthetic data. The extracted, refined, and synthetic data 651 may be fed into a cloud storage bucket 614 for storage and further processing. The system may accept input from various data sources and segregate only the relevant data required by the model, ensuring efficient processing and more accurate results.

A Model Function 616 may trigger a model update pipeline, reading data and pipeline specifications from the cloud storage bucket 614. This ensures that the E-Invoicing domain model 617 remains current with the latest regulatory requirements and document specifications. The Model Function 616 may transfer the processed data to the E-Invoicing domain model 617 through automated data pipelines that transform the extracted information into a format suitable for integration into the model's knowledge base. This technique enables the system to continuously adapt to new data from tax authorities, learning new patterns and updating technical documents accordingly.

In some embodiments, the E-Invoice Payload Generation Domain Model Process 600 may include three main functional areas that process the user's prompt: Prompt Data Segregation 618, Generation of e-invoice technical document component 620, and Validation of generated e-invoice technical document 622. These functional areas work together to process user inputs and produce compliant e-invoice documents, with clear data flows connecting each stage of the process.

The Prompt Data Segregation 618 may analyze and organize input data into distinct categories including Supplier Information 624, Buyer Information 626, Purchase Information 628, and Tax Information 630. This segregation may allow the system to process each type of information according to specific jurisdictional requirements. The segregated data flows from the Prompt Data Segregation 618 to the Generation of e-invoice technical document component 620 as indicated by the connecting arrow in the diagram.

In some embodiments, the Generation of e-invoice technical document component 620 may utilize the segregated data to create the technical document, including the Invoice/Credit note 632. The Invoice/Credit note 632 represents the output of the generation of e-invoice technical document component 620. The Generation of e-invoice technical document component 620 may leverage the E-Invoicing domain model 617 that has been updated with the latest requirements from various tax authorities to ensure that the generated document conforms to applicable standards and regulations. The output from the Generation of e-invoice technical document component 620 then flows to the Validation of generated e-invoice technical document 622 for validation, as shown by the connecting arrow.

In some embodiments, the Validation of generated e-invoice technical document 622 may implement a multi-stage validation process including XSD Validation 634 and Structural Schema (e.g., Schematron) Validation 636, which is implemented via the Tax Authority APIs 638. The XSD Validation 634 may verify the structural correctness of the document, while the Structural Schema Validation 636 may ensure compliance with domain-specific rules. The Tax Authority APIs 638 may connect to Tax Authority Endpoints 640 to verify compliance with jurisdiction-specific requirements. The validation results flow back to the E-Invoicing domain model 617 as feedback, creating a continuous improvement loop. This validation process may ensure that new technical documents are validated against tax rules to produce error-free and up-to-date invoices.

The system may implement LLM Monitoring 650 to track the performance of the large language models used in the document generation process via Model outputs and metrics or monitoring 658. The LLM Monitoring 650 may give feedback 656 on the generated document to the E-Invoicing domain model 617, creating a continuous improvement feedback loop 657 based on Model outputs and metrics or monitoring 658 as indicated by the feedback arrow in the diagram.

Once the document has been generated and validated, it may be delivered to the user in both technical document format 652 (e.g., XML) and its Human Readable Conversion 653 format (e.g., PDF). The user 644 may then at 654 choose to send the document generated along with feedback to the tax authority 640, completing the e-invoice submission process. This final step may instead be automatically performed by the E-Invoice payload generation domain model process 600, such as when instructed to do so by the prompts 646 or via an automated submission option selection made by the user 644. The system may seamlessly send validated data to tax authorities while maintaining compliance and accuracy.

In some embodiments, the entire process may operate as a closed-loop system where feedback from validation processes and user interactions may be incorporated back into the model, allowing the system to continuously learn and improve. This feedback flow is illustrated by the connections between the Validation of generated e-invoice technical document 622, the LLM Monitoring 650, and the E-Invoicing domain model 617. This technique may ensure that the Generative AI-powered E-Invoice Payload Generator remains accurate and up-to-date with evolving regulatory requirements across different jurisdictions.

The system may enable business computing systems to generate e-invoice payloads that comply with diverse regulatory requirements while operating across multiple jurisdictions simultaneously. For example, a customer needing to generate an e-invoice payload for Italy might provide details such as VAT number, supplier address, and recipient address. Using the generative AI model, including the E-Invoicing domain model 617, a compliant e-invoice payload would be automatically generated, fulfilling all required validations specific to Italy's jurisdiction. This would ensure the e-invoice is accurate, adheres to regulatory standards, and is ready for seamless processing within the Italian e-invoicing system.

In one example embodiment, the method includes the Data Extraction Module ingesting data into the e-invoicing domain model and training it with new patterns based on data received from legitimate sources. During this process, the e-invoicing domain model is capable of segregating prompt data, generating new technical documentation, and validating the technical documents.

In one example embodiment, the method involves the e-invoicing domain model receiving a request from the user through natural language prompts. The model then interprets the natural language input, uses the vector database to identify any corrections or updates required in the technical documents, and responds in real-time by sending the updated technical document back to the user.

In one example embodiment, the method involves the e-invoicing domain model validating the generated document against a validation framework, identifying errors, segregating them, and logging them for e-invoicing domain model monitoring.

In one example embodiment, the method involves the e-invoicing domain model learning from the monitored errors, forming a feedback loop that enhances its accuracy by continuously improving based on past mistakes.

In one example embodiment, the method involves the e-invoicing domain model automatically updating based on newly ingested data sources, seamlessly incorporating new rules and regulations for technical e-invoice document generation.

In one example embodiment, the method involves the e-invoicing domain model being capable of producing the technical document in multiple formats based on the user's input. The e-invoicing model then validates the document using internal validation mechanisms such as rule-based validation languages, XSD, and tax authority APIs to ensure the accuracy of the document. Finally, the e-invoicing domain model provides the validated and accurate technical document back to the user

In one example embodiment, the method involves the e-invoicing domain model separating the technical documentation of data sources into domain segments such as supplier information, buyer information, etc., and sending this information back to the vector database for embedding creation.

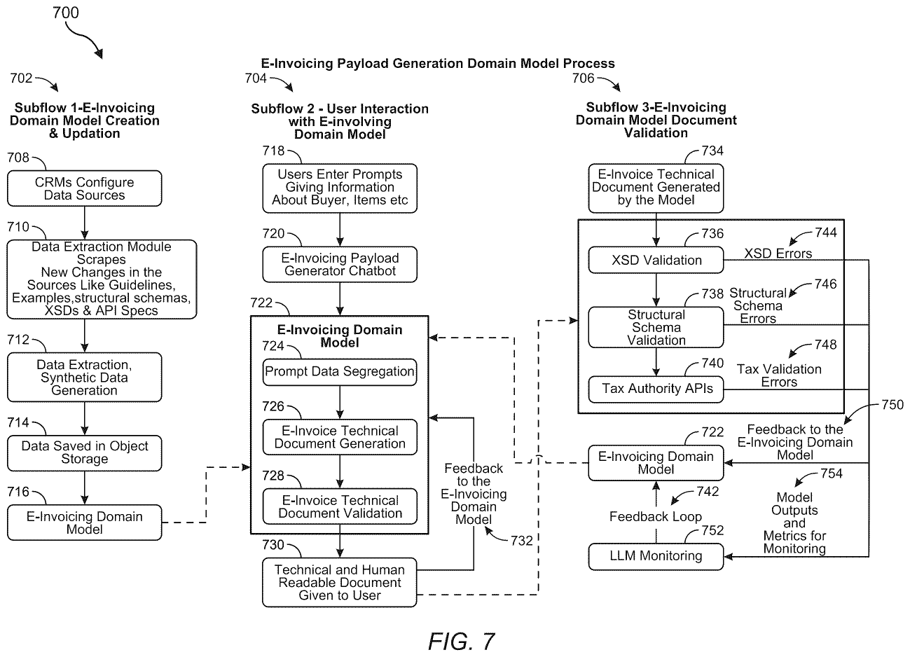

FIG. 7 illustrates an example flow diagram showing the E-Invoicing Payload Generation Domain Model Process 700, which depicts three interconnected subflows that work together to provide a comprehensive solution for e-invoice payload generation. The Generative AI-powered E-Invoice Payload Generator 583 of FIG. 5 and the applicable respective components of FIG. 6 may utilize these subflows to ingest data, process user interactions, and validate generated documents.

The flow diagram 700 is organized into three primary subflows: Subflow 1 (E-Invoicing Domain Model Creation & Updating) 702, Subflow 2 (User interaction with E-Invoicing Domain Model) 704, and Subflow 3 (E-Invoicing Domain Model Document Validation) 706. These subflows represent distinct functional components of the system that collaborate to deliver accurate and compliant e-invoice documents.

Subflow 1 (E-Invoicing Domain Model Creation & Updation) 702 begins with CRMs configuring data sources 708. This configuration may specify which external systems to connect with and what data to extract from each source. The process continues with the Data Extraction Module 710 scraping new changes in the sources like guidelines, examples, structural schema (e.g., schematrons), XSDs, and API specifications. The Data Extraction Module 710 serves as a continuous monitoring system that detects updates in regulatory requirements and document specifications across different tax authorities and jurisdictions.

Following the scraping operation, the system performs data extraction and synthetic data generation 712. This step may involve sophisticated algorithms that process the raw data obtained from various sources and generate additional synthetic data to enhance the training dataset. The extracted and synthetic data is then saved in object storage 714, creating a repository of information that can be used to train and update the e-invoicing domain model.

The E-Invoicing Payload Generation Domain Model Process 716 represents the central component of Subflow 1 702, which utilizes the stored data to create and maintain an accurate and up-to-date model for e-invoice generation. This model encapsulates the knowledge of document structures, validation rules, and domain-specific requirements across multiple jurisdictions.

Subflow 2 (User interaction with E-Invoicing Domain Model) 704 outlines the process flow from user input to document delivery. The process begins when users enter prompts 718 providing information about buyers, items, and other transaction details. These prompts may be in natural language and contain varying levels of detail about the transaction for which an e-invoice needs to be generated.

The E-Invoicing Payload Generator Chatbot 720 receives these user prompts and interfaces with the E-Invoicing Domain Model 722. The chatbot 720 may employ natural language processing capabilities to interpret user inputs and translate them into structured queries for the domain model.

In some embodiments, the system may implement a Prompt Data Segregation process 724 that parses the user input and organizes it into relevant categories such as supplier information, buyer information, and transaction details. This segregated data is then passed to the E-Invoice Technical Document Generation component 726, which produces the actual e-invoice document according to the applicable standards and requirements. For example, by implementing a tailored aggregator algorithm, the system may categorize an invoice into distinct entities (Customer Details, Supplier Details, Invoiced Items, Tax Details, etc.), and upon user prompts, the customized generative AI algorithm of the e-invoicing domain model, made on top of data fed by Feeder Engine, intelligently identifies the applicable jurisdiction, retrieves pertinent information, seamlessly integrates it into the correct positions, combines the previously segregated entities, generates a comprehensive e-invoice payload comprising a technical document.

The generated technical document undergoes rigorous validation through the E-Invoice Technical Document Validation process 728. Once validated, both the Technical and Human Readable Document 730 are provided to the user. This dual-format delivery may enhance usability by providing both a machine-processable document for electronic submission and a human-readable version for review and record-keeping.

Importantly, the system incorporates a feedback loop 732 that routes validation results and user interactions back to the E-Invoicing Domain Model 722. This feedback mechanism enables continuous learning and improvement, ensuring that the model adapts to changing requirements and refines its document generation capabilities over time.

Subflow 3 (E-Invoicing Domain Model Document Validation) 706 details the validation processes applied to generated documents. When an E-Invoice Technical Document 734 is generated by the model, it undergoes multiple validation stages. First, XSD Validation 736 verifies the structural correctness of the document against XML Schema Definitions. This ensures that the document conforms to the basic structural requirements of the target format.

Next, Structural Schema Validation 738 checks compliance with domain-specific rules that may not be captured by the XML schema alone. These rules may include complex business logic, interdependencies between fields, and jurisdiction-specific requirements that must be satisfied for the document to be valid.

The validation process then continues with validation via Tax Authority APIs 740, which may involve submitting the document to test endpoints provided by tax authorities to verify compliance with their specific requirements. For example, the system may submit the technical document to the tax authority's test portal. The portal subsequently evaluates the incoming invoice, providing user feedback by conveying the generated payload and any associated errors. This step provides an additional layer of assurance that the generated document will be accepted when officially submitted.

The validation results from all three stages flow into a Feedback Loop 742, which categorizes and processes the information. XSD errors 744, Structural Schema (e.g., Schematron) errors 746, and tax authority (TA) Validation errors 748 are all tracked and analyzed to identify patterns and improvement opportunities. This processed feedback 750 is then sent to the E-Invoicing Domain Model 722 to refine future document generation.

The system also implements LLM Monitoring 752 to track the performance of the language models used in the document generation process. This monitoring generates Model Outputs and Metrics for Monitoring 754, which provide insights into model performance and may help identify areas for optimization.

The comprehensive workflow illustrated in FIG. 7 demonstrates how the Generative AI-powered E-Invoice Payload Generator integrates data ingestion, user interaction, document generation, and validation into a cohesive system. This integrated technique enables businesses to generate compliant e-invoice documents across multiple jurisdictions with minimal manual effort, reducing errors and ensuring regulatory compliance.

The feedback mechanisms incorporated throughout the system enable continuous learning and adaptation, ensuring that the E-Invoicing Domain Model remains current with evolving regulatory requirements and improves its document generation capabilities over time. This adaptive quality may be particularly valuable in the context of e-invoicing, where document requirements and validation rules frequently change as tax authorities update their systems and regulations.

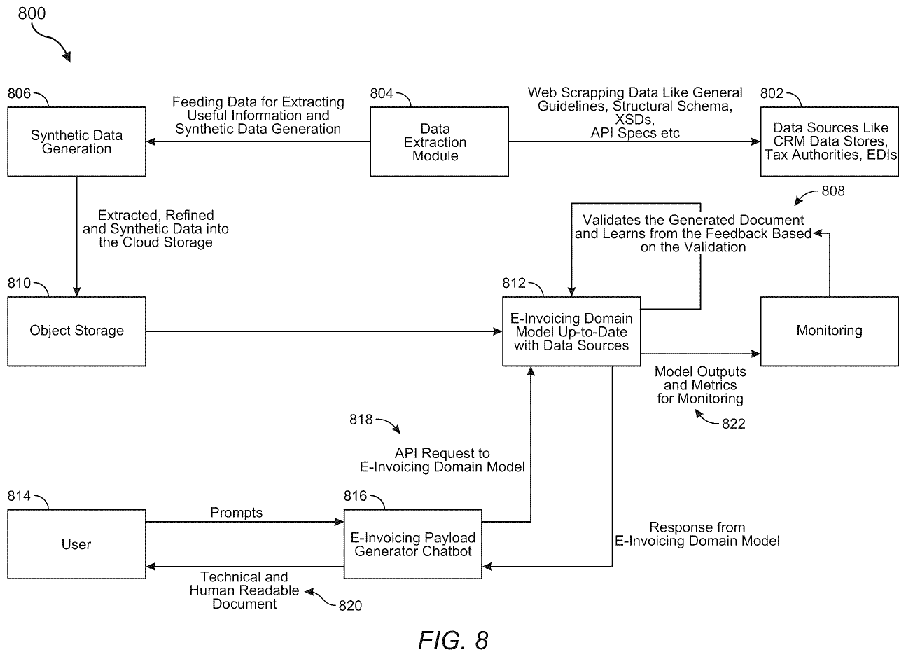

FIG. 8 illustrates a system architecture diagram of a Generative AI-powered E-Invoice Payload Generator 800, which may be an example of the E-Invoice Payload Generator 583 of FIG. 5, illustrating the data flow and components involved in the e-invoice generation process. The architecture demonstrates how various system components, such as those in FIG. 6, interact to extract data from multiple sources, process this information, and deliver accurate e-invoice payloads to users.

Data Sources 802 are shown, which may include CRM Data Stores, Tax Authorities, and EDIs (Electronic Data Interchange sources). These sources provide the foundational information needed to generate compliant e-invoices across various jurisdictions. The Data Sources 802 connect to the Data Extraction Module 804, which performs web scraping of data like general guidelines, structural schema (e.g., schematrons), XSDs, and API specifications from these sources.

The Data Extraction Module 804 plays an important role in monitoring data sources and capturing changes in regulatory requirements, document specifications, and validation rules. When new information becomes available from tax authorities or other relevant sources, the Data Extraction Module 804 extracts this data and feeds it into the system for further processing. This continuous monitoring and updating mechanism ensures that the e-invoice generation system remains current with the latest compliance requirements.

The extracted data flows to the Synthetic Data Generation component 806, which refines and enriches the raw data. This component refines data for generating useful information and performs synthetic data generation. The synthetic data may be used to enhance training datasets, fill gaps in available information, and improve the system's ability to handle edge cases. In some embodiments, the synthetic data generation may employ machine learning techniques to create realistic but artificially generated examples that help train the model for situations not well-represented in the available real data.

The refined and synthetic data is then fed into the cloud storage 808, creating a comprehensive knowledge base for the e-invoicing system. This cloud storage 808 may serve as a repository for all the extracted and processed information, making it available for model training and document generation. The system validates the generated document and learns from the feedback based on the validation.

The Object Storage 810 component may maintain a structured repository of all the information needed by the E-Invoicing Domain Model 812. The E-Invoicing Domain Model 812 is kept up-to-date with data sources through regular updates and refinements based on new information and feedback from document validation processes.

A User 814 interacts with the system through the E-Invoicing Payload Generator Chatbot 816, which provides a conversational interface for requesting e-invoice generation. The user can submit prompts describing the desired invoice, and the chatbot processes these natural language inputs into structured requests for the domain model.

The E-Invoicing Payload Generator Chatbot 816 sends an API Request 818 to the E-Invoicing Domain Model 812, which then processes the request and generates the appropriate e-invoice payload. The response from the E-Invoicing Domain Model 812 includes both Technical and Human Readable Documents 820, which are delivered back to the user 814.

The system also includes a monitoring component that tracks Model Outputs and Metrics for Monitoring 822. This monitoring enables performance assessment, identifies improvement opportunities, and helps ensure the system maintains high accuracy and compliance rates. The metrics may include validation success rates, error patterns, processing times, and other key performance indicators relevant to e-invoice generation.

The architecture effectively combines data extraction, model training, user interaction, and document generation into an integrated system that can produce compliant e-invoices across multiple jurisdictions. The data flow paths shown in the diagram demonstrate how information moves through the system, from initial extraction to final document delivery.

The use of cloud storage 808 and object storage 810 provides scalability and flexibility, enabling the system to handle large volumes of data and serve multiple users simultaneously. These storage components also facilitate rapid updates to the domain model when new regulatory requirements are identified or existing rules are changed.

In some embodiments, the system may employ additional security measures not explicitly shown in the diagram, such as encryption of sensitive information, access control mechanisms, and audit logging to ensure the confidentiality and integrity of the generated documents and the data used to create them.

The architecture highlighted in FIG. 8 employs a data-driven technique to e-invoice generation, where the system continuously learns and improves based on new data and feedback. This technique enables the Generative AI-powered E-Invoice Payload Generator to maintain accuracy and compliance in the face of evolving regulatory requirements across different jurisdictions.

The separation of data extraction (Data Extraction Module 804), data enrichment (Synthetic Data Generation 806), data storage (cloud storage 808 and Object Storage 810), and model application (E-Invoicing Domain Model 812) creates a modular architecture that can be maintained and updated efficiently. Each component can be enhanced or replaced independently without requiring a complete system redesign, facilitating ongoing improvement and adaptation to changing requirements.

The integration of the E-Invoicing Payload Generator Chatbot 816 as the primary user interface simplifies the process of requesting e-invoice generation, making the system accessible to users without deep technical knowledge of e-invoice formats or regulatory requirements. This design choice enhances usability while still leveraging the sophisticated capabilities of the underlying AI model.

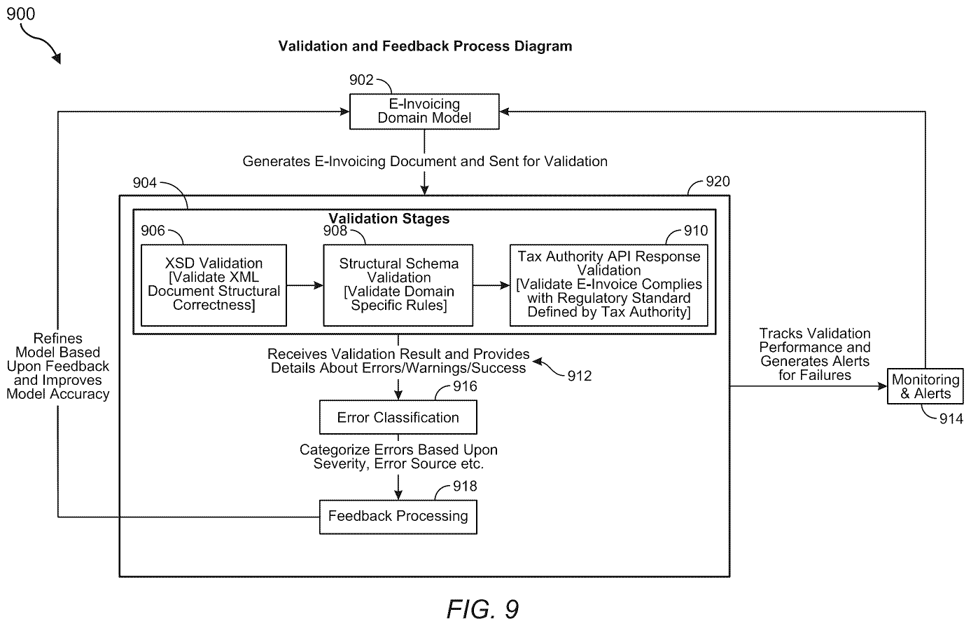

FIG. 9 illustrates a detailed validation and feedback process diagram 900 of the Generative AI-powered E-Invoice Payload Generator 583 of FIG. 5, expanding upon the validation components introduced in FIGS. 6, 7, and 8. This diagram focuses specifically on the validation stages and feedback mechanisms that ensure the generated e-invoice documents comply with applicable regulatory requirements and technical specifications.

The E-Invoicing Domain Model 902 serves as a component of the validation process, generating e-invoicing documents that are subsequently sent for comprehensive validation. This model corresponds to the E-Invoicing Domain Model 617 in FIGS. 6 and 722 in FIG. 7. When an e-invoice document requires generation, the E-Invoicing Domain Model 902 creates the document based on the provided inputs and sends it through the validation pipeline.

The validation process encompasses multiple stages gathered under the Validation Stages section 904 of the Validation Module 920. This multi-stage validation technique provides thorough verification of the document's compliance with technical standards and regulatory requirements. The three primary validation stages include XSD Validation 906, Structural Schema Validation 908, and Tax Authority API Response Validation 910.

XSD Validation 906 verifies the XML Document Structural Correctness, ensuring that the generated document adheres to the defined XML Schema Definition (XSD) structure. This stage checks for proper formatting, required fields, data types, and structural relationships within the document. XSD Validation 906 represents a foundational level of validation that addresses the technical format requirements of e-invoice documents.

Structural Schema Validation 908 extends beyond structural validation to verify Domain Specific Rules. While XSD validation confirms that a document meets structural requirements, Structural Schema Validation ensures that the content adheres to business rules and logic specific to particular domains or jurisdictions. This may include checking for proper tax code usage, ensuring consistent information across different document sections, or validating complex interdependencies between fields.

Tax Authority API Response Validation 910 provides the final validation step, confirming that the e-invoice complies with regulatory standards defined by the tax authority. This stage may involve submitting the document to test endpoints provided by tax authorities and analyzing the responses to identify any compliance issues. This validation stage is particularly valuable for catching jurisdiction-specific requirements that might not be fully captured in standardized schemas.

In some embodiments, additional validation techniques might be employed, such as cryptographic validation of digital signatures or verification against historical transaction records to ensure consistency in recurring transactions.

After validation, the system sends the validation results and provides details about error/warnings/success 912 to the Error Classification component 916. This step involves processing the validation results from all stages, aggregating the information, and preparing detailed feedback about any issues identified. The detailed feedback enables both the system and users to understand precisely what aspects of the document may need attention or correction. \

The Error Classification component 916 Categorizes errors based on severity, error source, etc. This classification may enable prioritized handling of issues, with critical errors addressed immediately while minor warnings might be logged for future improvement. Error classification may also facilitate trend analysis, helping identify recurring issues that might indicate opportunities for model enhancement.

The categorized errors are then transmitted to the Feedback Processing component 918, which represents an important aspect of the system's learning capability. This component processes validation results and error classifications to refine the model and improve its accuracy over time by sending the feedback to the E-Invoicing Domain Model 902. The feedback loop creates a self-improving system that continuously enhances its ability to generate compliant documents based on real-world validation outcomes.

The Monitoring & Alerts component 914 continuously tracks validation performance from the Validation Module 920 and generates alerts for failures. This monitoring function provides operational visibility into the system's performance and enables proactive intervention when validation failures occur. By tracking validation metrics over time, the system can identify patterns or trends that might indicate systematic issues requiring attention.

The E-Invoicing Domain Model 902 refines the E-Invoicing Domain Model 902 based upon feedback and improves model accuracy by incorporating the processed feedback. This continuous learning mechanism enables the system to adapt to new requirements, address identified issues, and enhance its document generation capabilities over time. The feedback loop shown in the diagram illustrates how validation results flow back into the model, creating a cycle of continuous improvement.

The validation and feedback process depicted in FIG. 9 demonstrates the error-handling and improvement mechanisms implemented in the Generative AI-powered E-Invoice Payload Generator 583 of FIG. 5. This validation technique ensures that generated documents meet all applicable requirements while the feedback mechanisms enable continuous system enhancement. In particular, the multi-layered validation technique provides defense-in-depth, with each validation stage addressing different aspects of document compliance. This technique increases the likelihood of catching errors or compliance issues before documents are officially submitted to tax authorities, reducing the risk of rejected submissions or penalties for non-compliance.

The detailed feedback and error classification capabilities enable precise identification of issues, facilitating targeted improvements to the E-Invoicing Domain Model 902. Rather than simply indicating that a document failed validation, the system identifies specific errors, their sources, and their severity, providing rich information for model refinement. The monitoring and alerting functions also provide operational visibility and enable timely intervention when issues arise. These capabilities are particularly important in production environments where document generation failures could impact business operations or compliance status.

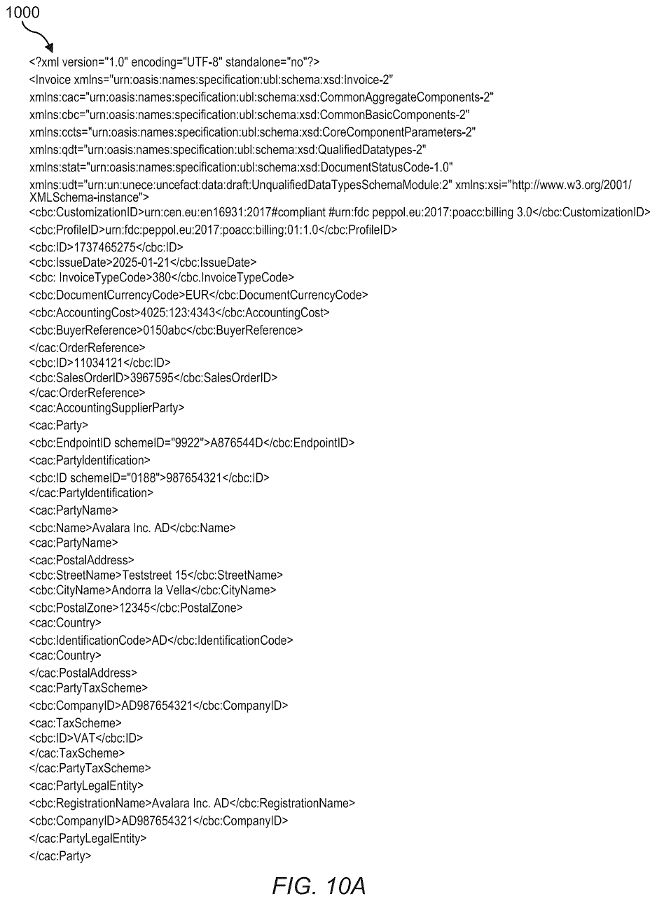

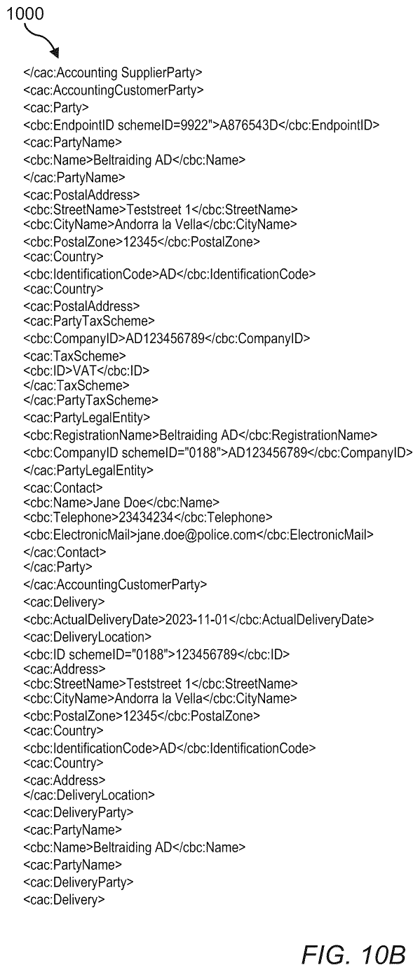

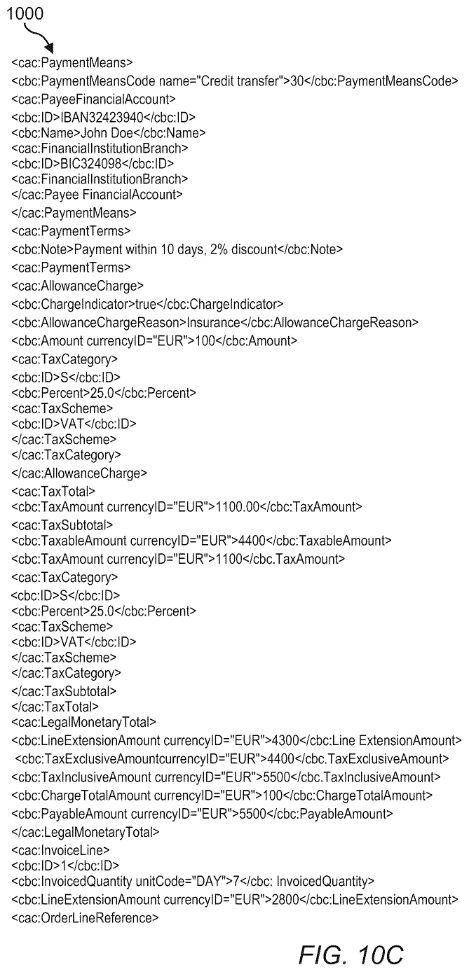

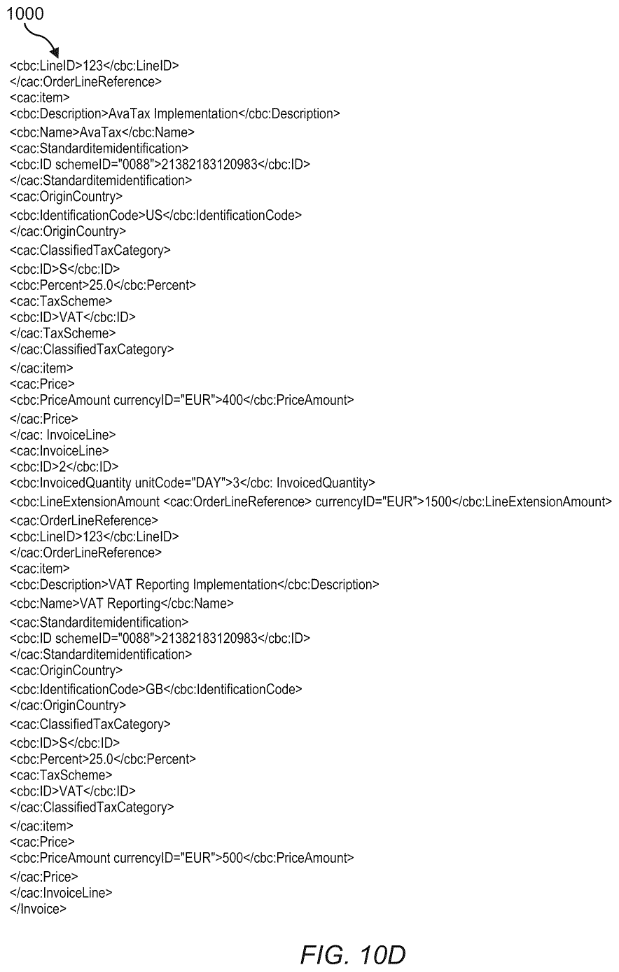

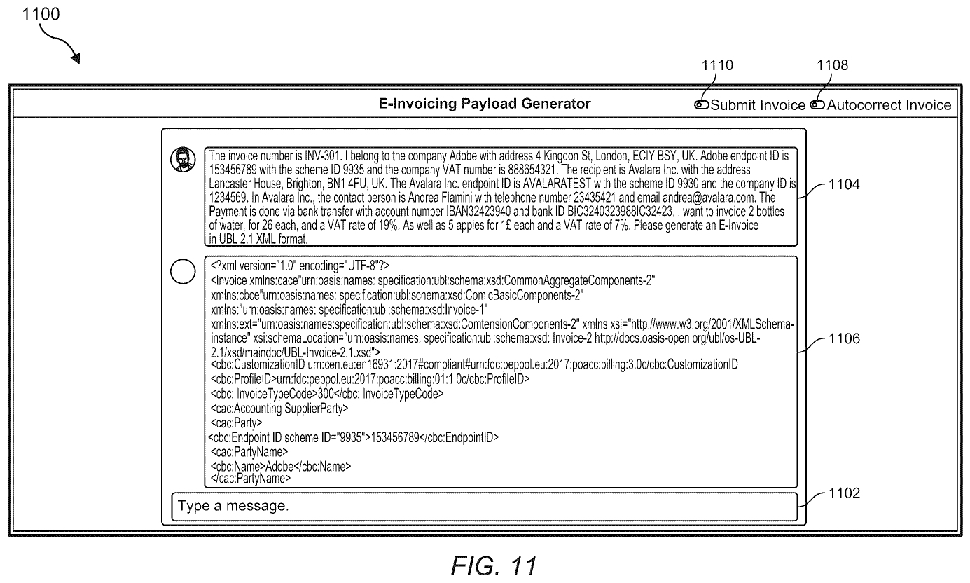

FIGS. 10A-10D collectively illustrate an example of a technical e-invoice document 1000 in XML format that has been automatically generated by the Generative AI-powered E-Invoice Payload Generator system described in the previous figures represented by the invoice generation system 502 of FIG. 5. This example demonstrates the actual output produced by the Generation of e-invoice technical document component 620 (FIG. 6) and corresponds to the technical document format 652 referenced in FIG. 6 and the Technical Response 820 shown in FIG. 8.

The XML document 1000 shown across FIGS. 10A-10D represents a complete, structured e-invoice that adheres to a standardized format—in this case, the Universal Business Language (UBL) 2.1 standard for invoice documents. This document may be generated after a user submits a prompt through the E-Invoice Payload Generator Chatbot 642 (FIG. 6) or 720 (FIG. 7), which triggers the document generation process in the E-Invoicing Domain Model 617 (FIG. 6) or 722 (FIG. 7).

FIG. 10A shows the initial portion of the XML document 1000, including the XML declaration and namespace definitions that establish the document's compliance with specific standards. The figure displays important invoice header information such as customization and profile identifiers, invoice number, issue date, invoice type, and currency details. The header section also contains references to order information that links this invoice to previous business transactions.

The XML document continues in FIG. 10A with the AccountingSupplierParty section, which contains detailed information about the invoice issuer. This includes the supplier's endpoint identification, party identification, name, address, tax information, and legal entity details. All this structured information is automatically populated by the system based on the input data provided in the user's prompt and supplemented with information from the E-Invoicing Domain Model.

FIG. 10B continues the XML document 1000, showing the AccountingCustomerParty section that contains structured information about the invoice recipient. Like the supplier section, this includes endpoint identification, name, address, tax information, and legal entity details. FIG. 10B also shows contact information for the customer, including name, telephone, and email. Additionally, it displays delivery information, including delivery date, location, and party details.

FIG. 10C displays the payment and financial information sections of the XML document 1000. This includes payment means, financial account information, payment terms, and allowance/charge information. The figure also shows the tax information section, detailing tax amounts, taxable amounts, percentages, and tax categories. The LegalMonetaryTotal section summarizes the financial aspects of the invoice, including line extension amount, tax exclusive amount, tax inclusive amount, and payable amount.

FIG. 10D concludes the XML document 1000 with the InvoiceLine sections that detail the specific items being invoiced. Each invoice line includes an ID, quantity information, amount, order reference, item description, item identification, country of origin, tax category, and price information. The example shows multiple invoice lines for different products or services, each with their respective details properly structured according to the XML schema requirements.

This technical XML document 1000 is automatically generated by processing user input through several system components. The E-Invoice Payload Generator Chatbot 642 (FIG. 6) or 816 (FIG. 8) receives the user's prompt and forwards this information to the Prompt Data Segregation component 618 (FIG. 6) or 724 (FIG. 7). The segregated data is then processed by the Generation of e-Invoice Technical Document component 620 (FIG. 6) or 726 (FIG. 7), which leverages the E-Invoicing Domain Model to produce this structured XML document.

Before being delivered to the user, the generated XML document 1000 undergoes validation through the multi-stage validation process described in FIG. 9. This includes XSD Validation 906 to verify structural correctness, Structural Schema Validation 908 to check domain-specific rules, and potentially Tax Authority API Response Validation 910 to ensure regulatory compliance. Any validation issues would be addressed through the feedback mechanisms before the final document is delivered.

The system transforms unstructured or semi-structured user input into a highly structured, technically compliant XML document that adheres to specific standards and requirements. This transformation leverages the knowledge encoded in the E-Invoicing Domain Model, which contains information about document structures, field requirements, validation rules, and jurisdiction-specific regulations gathered from various authoritative sources.

In some embodiments, the technical document may be generated in formats other than XML, such as JSON, EDI X12, EDIFACT, or other structured data formats depending on the requirements of the receiving system or tax authority. The underlying generation process remains similar, with the system applying the appropriate formatting rules based on the target format.

The technical document shown in FIGS. 10A-10D may be accompanied by a human-readable representation, such as a PDF document, that presents the same information in a more visually accessible format for users who may not be familiar with XML or other technical formats. This dual-format delivery, as shown in component 648 (FIG. 6) or 820 (FIG. 8), enhances usability while ensuring that the document meets technical requirements for electronic processing and submission.

FIG. 11 illustrates an example user interface 1100 of the Generative AI-powered E-Invoice Payload Generator system, showing how users interact with the system to generate and manage e-invoice documents. This interface may correspond to the E-Invoice Generation Interface 591 of FIG. 5 and the user-facing component of the E-Invoice Payload Generator Chatbot 642 depicted in FIGS. 6 and 720 in FIG. 7, providing a practical implementation of how users engage with the system.

The user interface 1100 features a prompt input field 1102 where users can enter natural language instructions for generating an e-invoice payload. This input field directly connects to the functionality described in previous figures, particularly the user interaction aspects shown in Subflow 2 (704) of FIG. 7 where users enter prompts giving information about buyers, items, and other transaction details. The prompt input field 1102 serves as the primary means for users to communicate their e-invoice generation requirements to the system.

Displayed within the interface is an example prompt 1104 that has already been entered by the user. This example prompt 1104 demonstrates the natural language input capability of the system, showing how users can describe invoice requirements in everyday language rather than technical specifications. The prompt contains details about the transaction, including information about the seller, buyer, items sold, prices, tax rates, and the desired output format. This aligns with the prompt examples described earlier and demonstrates how the Prompt Data Segregation component 618 (FIG. 6) receives its input data.

The interface displays the resulting generated e-invoice payload 1106 in XML format, which was produced by the system based on the example prompt 1104. This XML output corresponds to the technical document format 652 referenced in FIG. 6 and represents the actual product of the Generation of e-invoice technical document component 620 (FIG. 6). The XML payload shown is similar to the complete example illustrated in FIGS. 10A-10D, though typically displayed in a scrollable window to accommodate its length.

The user interface 1100 includes an autocorrection option toggle switch 1108 that enables users to turn on or off the automatic correction functionality for issues detected in the generated e-invoice. When activated, this feature would automatically trigger corrections based on the validation and feedback processes detailed in FIG. 9, particularly the Error Classification 916 and Feedback Processing 918 components. In FIG. 11, the autocorrection toggle switch 1108 is shown in the “off” position, indicating that automatic corrections will not be applied without user review. When turned on, the autocorrection functionality may leverage the system's knowledge of common errors and domain-specific requirements to fix issues automatically as soon as the prompt is entered, without requiring manual user intervention.

A submit to tax authority toggle switch 1110 is also displayed, providing users with the option to enable or disable automatic submission of the generated e-invoice to the relevant tax authority after generation. This submission functionality relates to the final stage described in FIG. 6, where the validated document may be sent to Tax Authority Endpoints 640. In FIG. 11, this toggle switch 1110 is shown in the “off” position, indicating that automatic submission is not currently enabled. When turned on, the system would automatically submit the generated document to the appropriate tax authority immediately after generation and validation, streamlining the workflow by eliminating the need for manual submission steps. The toggle switches for autocorrection and tax authority submission provide users with configurable automation options that can be adapted to their specific workflow preferences.

The layout of the user interface 1100 emphasizes usability while providing access to the sophisticated functionality of the underlying system. The natural language input capability, combined with automatic document generation and validation, significantly reduces the technical expertise required to create compliant e-invoice documents. This technique enables improved access to e-invoicing capabilities, making them accessible to users without specialized knowledge of document formats or regulatory requirements.

In some embodiments, the interface may include additional optional features not shown in FIG. 11, such as a document format selector that provides users with options to switch between different technical formats for the generated document, or a document history section that lists previously generated documents. These optional features may be implemented based on specific user requirements or use cases.

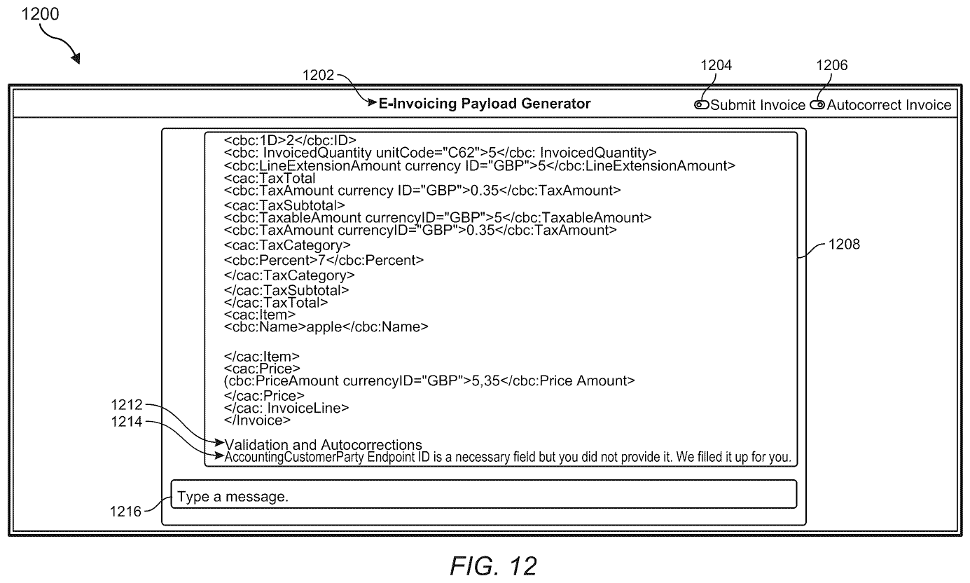

FIG. 12 illustrates an example user interface 1200 showing the validation and autocorrection feedback provided by the Generative AI-powered E-Invoice Payload Generator system after an e-invoice has been generated with the autocorrection feature enabled. This interface directly relates to the validation and feedback processes described in FIG. 9, particularly the Error Classification 916 and Feedback Processing 918 components, and demonstrates how validation results are communicated to users in a clear, actionable format.

The user interface 1200 displays the E-Invoicing Payload Generator title 1202 at the top of the screen, establishing the context for the user interaction. This header identifies the application and provides continuity with the interface shown in FIG. 11, indicating that the user is working with the same system throughout the e-invoice generation process.

In the upper right corner of the interface, two toggle options are visible: the Submit Invoice toggle 1204 and the Autocorrect Invoice toggle 1206. The Autocorrect Invoice toggle 1206 is shown in the “on” position, indicating that the system has automatically applied corrections to the generated e-invoice based on validation findings, demonstrating the practical implementation of the feedback mechanisms described in FIG. 9.

The central portion of the interface displays the generated e-invoice payload 1208 in XML format, which corresponds to the technical document output from the Generation of e-invoice technical document component 620 (FIG. 6). The XML content shows various invoice elements including quantities, tax information, amounts, and other structured data that conforms to a standardized e-invoice format.

Below the XML content, the Validation and Autocorrections section 1212 provides crucial feedback about issues identified during validation and the automatic corrections applied by the system. This section implements the output of the Validation Stages 904 processes described in FIG. 9, translating technical validation results into user-friendly notifications.

The autocorrection message 1214 informs the user: “AccountingCustomerParty Endpoint ID is a necessary field but you did not provide it. We filled it up for you.” This message identifies a specific validation issue (missing required field), explains its importance (necessary field), and describes the corrective action taken by the system (automatic completion). This notification ensures that automatically applied changes are transparent to the user.

At the bottom of the interface, a message input field 1216 enables users to enter follow-up queries or instructions related to the generated document. This interactive element facilitates ongoing conversation with the E-Invoice Payload Generator Chatbot 642 (FIG. 6) or 720 (FIG. 7), supporting an iterative refinement process.

The validation and autocorrection functionality displayed in FIG. 12 implements a critical component of the E-Invoicing Domain Model Document Validation subflow 706 described in FIG. 7. When validation issues are detected through the XSD Validation 736, Structural Schema Validation 738, or Tax Authority APIs 740 processes, the system not only identifies these issues but also applies appropriate corrections based on its understanding of e-invoice requirements and domain-specific rules.

In some embodiments, the system may implement different levels of autocorrection based on the severity and certainty of the identified issues. Critical and unambiguous issues might be corrected automatically, while more subjective or context-dependent issues might prompt user confirmation before changes are applied.

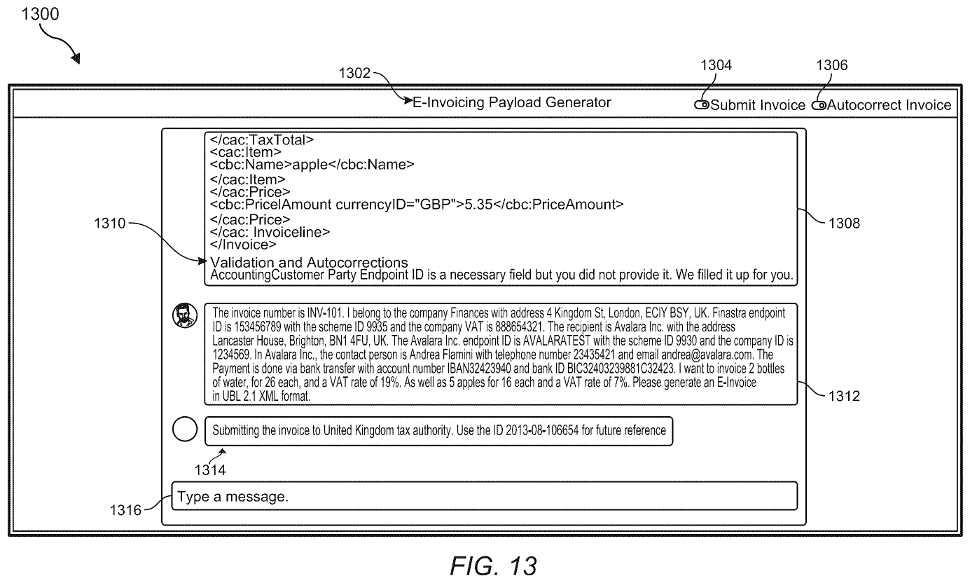

FIG. 13 illustrates an example user interface 1300 showing the e-invoice submission process of the Generative AI-powered E-Invoice Payload Generator system when the submit invoice option has been selected. This interface demonstrates the implementation of the document submission functionality referenced in previous figures, particularly the connection to step 654 and Tax Authority Endpoints 640 described in FIG. 6. The interface 1300 provides visual confirmation of the submission process and displays relevant tracking information for future reference.

The user interface 1300 displays the E-Invoicing Payload Generator title 1302 at the top of the screen, maintaining consistent context across the system's different screens. This header identifies the application and connects this view with the interfaces shown in FIGS. 11 and 12, showing progression through the e-invoice generation and submission workflow.

In the upper right corner of the interface, two toggle options are visible: the Submit Invoice toggle 1304 and the Autocorrect Invoice toggle 1306. The Submit Invoice toggle 1304 is shown in the “on” position, indicating that the system is automatically submitting the generated e-invoice to the appropriate tax authority. This functionality corresponds to the final step in the e-invoicing process where validated documents are transmitted to tax authority systems for official filing.

The central portion of the interface displays the generated e-invoice payload 1308 in XML format, which shows the technical document that has been created based on the user's input and validated according to the multi-stage validation process described in FIG. 9. The XML content displays the final version of the document that is being submitted to the tax authority.

Below the XML display, the Validation and Autocorrections section 1310 shows feedback from the validation process, specifically indicating that “AccountingCustomerParty Endpoint ID is a necessary field but you did not provide it. We filled it up for you.” This message demonstrates the system's capability to identify and correct issues before submission, implementing the validation and feedback mechanisms detailed in FIG. 9.

The original prompt 1312 is displayed in the middle section of the interface, showing the natural language text that the user initially entered to generate the e-invoice. The prompt contains detailed information about the transaction, including invoice number, company information, addresses, contact details, payment methods, items, quantities, prices, and tax rates. This display provides a reference point connecting the user's original input to the generated technical document and submission process.

The submission notification 1314 appears prominently on the interface with an alert icon, informing the user: “Submitting the invoice to United Kingdom tax authority. Use the ID 20337-46-166954 for future reference.” This notification implements an important user communication aspect of the submission process, confirming the action being taken and providing a reference identifier for tracking purposes. The reference ID enables users to query the status of their submission or reference the filing in future communications with tax authorities or within their own record-keeping systems.

At the bottom of the interface 1300, a message input field 1316 enables users to enter follow-up queries or instructions. This interactive element facilitates ongoing conversation with the E-Invoice Payload Generator Chatbot, supporting an iterative refinement process and enabling users to ask questions about the submission process or request additional information about their submitted document.

The submission process displayed in FIG. 13 represents the implementation of the final stage in the e-invoicing workflow, where the validated document is transmitted to the appropriate tax authority endpoint. This process builds upon the document generation and validation stages shown in previous figures, completing the end-to-end workflow from user prompt to official submission. By mitigating the risk of non-compliance and potential financial penalties for customer-sent e-invoices, an example embodiment of the system described herein is tailored to streamline cross-border transactions. This technique facilitates the generation of e-invoice payloads that align with tax regulations and data formats in both the supplier's and recipient's jurisdictions. Businesses operating in multiple jurisdictions can benefit from this system, allowing them to allocate resources efficiently towards their core operations while maintaining compliance with the diverse regulatory standards of each jurisdiction. An example embodiment of the system simplifies e-invoicing workflows by automating the generation process, minimizing errors, and saving valuable time for businesses.

The embodiments described above may also use synchronous or asynchronous client-server computing techniques, including software-as-a-service (SaaS) techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, a microservice architecture, and implementations or instances running on one or more computer systems each having one or more CPUs. Some embodiments may execute concurrently and asynchronously, and communicate using message passing techniques. Requests and responses form and to multiple customers or clients may be processed simultaneously and/or concurrently in various embodiments, thereby increasing throughput and timeliness of responses over the computer networks and the computer systems. Equivalent synchronous embodiments are also supported. Also, other functions could be implemented and/or performed by each component/module, and in different orders, and by different components/modules, yet still achieve the functions of the systems and methods described herein.

In addition, programming interfaces to the data stored as part of the system controller 210 and other system components described herein may be available by mechanisms such as through C, C++, C #, Python and Java APIs; libraries for accessing files, databases, or other data repositories; through scripting languages such as JavaScript and VBScript; or through Web servers, FTP servers, or other types of servers providing access to stored data. The databases described herein and other system components may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, RESTful (REST) APIs, Web Services (XML-RPC, JAX-RPC, SOAP, and the like). Other variations are possible. Also, other functionality may be provided by each component/module, or existing functionality could be distributed amongst the components/modules in different ways, yet still achieve the functions described herein.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

As used herein, the term “or” may be construed in either an inclusive or exclusive sense. Moreover, plural instances may be provided for resources, operations, or structures described herein as a single instance. Additionally, particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, including:
at least one processor; and
a memory coupled to the at least one processor, the memory storing instructions that, when executed by the at least one processor, cause the system to perform operations, the operations including:
electronically ingesting data from a plurality of data sources including domain entity websites, electronic data interchange (EDI) providers and customer relationship management (CRM) data stores;
electronically extracting relevant data from the ingested data;
electronically generating embeddings of the extracted data and storing the embeddings in a vector database;
maintaining the vector database with current electronic document requirements for multiple domains;
electronically receiving a prompt from a user device, the prompt including information about a first entity, a second entity, and relationship instance details;
in response to receiving the prompt, using a large language model (LLM) to electronically analyze and segregate the prompt data into separate components including at least first entity information, second entity information, and relationship instance information;
electronically querying the vector database using the segregated prompt data to identify domain-specific requirements applicable to the relationship instance;
using the LLM to electronically generate a technical document based on the segregated prompt data and the identified domain-specific requirements;
electronically validating the generated technical document through a multi-stage validation process including at least structural validation, domain-specific rule validation, and domain entity response validation;
using the LLM to electronically process feedback regarding validation errors to refine subsequent document generation; and
electronically delivering the validated document to the user device in both technical format and human-readable format.

2. The system of claim 1, in which electronically ingesting data from the plurality of data sources includes implementing a web scraping mechanism configured to automatically monitor and detect updates to domain entity websites.

3. The system of claim 1, in which electronically extracting relevant data from the ingested data includes identifying and extracting document structure specifications, validation rules, and domain-specific terminology from the ingested data.

4. The system of claim 1, in which electronically generating embeddings of the extracted data includes:
creating vector representations of domain-specific requirements for each domain; and
organizing the vector representations into clusters based on similarity of requirements across domains.

5. The system of claim 1, in which maintaining the vector database includes:
automatically detecting changes in domain entity requirements;
updating corresponding vector representations in the vector database; and
logging the changes with timestamps to maintain a historical record of requirement modifications.

6. The system of claim 1, in which electronically receiving a prompt from a user device includes receiving a natural language description of a desired document without requiring specific formatting or domain knowledge from a user.

7. The system of claim 1, in which using the LLM to electronically analyze and segregate the prompt data includes using a nearest-neighbor algorithm to match prompt elements with corresponding document components based on vector similarity.

8. The system of claim 1, in which electronically querying the vector database includes:
determining the domains applicable to both the first entity and the second entity; and
identifying cross-domain requirements applicable to the relationship instance.

9. The system of claim 1, in which using the LLM to electronically generate a technical document includes:
generating a document object model (DOM) representation of the technical document;
populating required fields based on the segregated prompt data; and
automatically generating placeholder values for any missing required fields.

10. The system of claim 9, in which the operations further include notifying a user of any automatically generated placeholder values and providing an interface for the user to modify or confirm the placeholder values.

11. The system of claim 1, in which the structural validation includes validating the generated technical document against XML Schema Definitions (XSDs) to facilitate document structural correctness.

12. The system of claim 1, in which the domain-specific rule validation includes validating the generated technical document against Schematron rules to facilitate compliance with domain-specific rules.

13. The system of claim 1, in which the domain entity response validation includes submitting the generated technical document to a test endpoint provided by a domain entity and processing the response to identify any compliance issues.

14. The system of claim 1, in which using the LLM to electronically process feedback includes:
categorizing validation errors based on error type and severity;
updating model parameters based on error patterns; and
refining document generation templates to prevent recurring errors.

15. The system of claim 1, in which electronically delivering the validated document includes:
generating an XML format of the technical document;
generating a human-readable PDF format of the technical document; and
providing both formats to the user device with annotations indicating the correlations between elements in both formats.

16. The system of claim 1, in which the operations further include:
maintaining an electronic log of document generation transactions;
recording success and failure metrics for each transaction; and
generating performance analytics to identify improvement opportunities in the document generation process.

17. The system of claim 1, in which the operations further include electronically submitting the validated document to a domain entity on behalf of the user upon receiving user authorization.

18. The system of claim 1, in which the operations further include:
detecting changes in domain requirements that affect previously generated documents;
automatically notifying users of such changes; and
providing an option to regenerate affected documents with updated requirements.

19. The system of claim 1, in which the operations further include implementing a synchronization mechanism that facilitates consistency between the vector database and current domain entity requirements by periodically validating and updating the vector database against authoritative sources.

20. The system of claim 1, in which the operations further include:
encrypting sensitive information contained within the generated technical document;
generating access logs tracking all interactions with the document; and
implementing digital verification mechanisms to authenticate an origin and integrity of the document.

21-60. (canceled)
